(19) United States
(12) Patent Application Publication
(10) Pub. No.: US 2025/0021991 A1
(43) Pub. Date: Jan. 16, 2025

(54) SYSTEM AND METHOD FOR ORCHESTRATING THE DETERMINATION OF A PRODUCT CARBON FOOTPRINT

(71) Applicant: Chevron U.S.A. Inc., San Ramon, CA (US)

(72) Inventors: Derek Alexander de Oliveira, Meadow Vista, CA (US); Laura Michelle Kurt Seymour, Lafayette, CA (US); Julie Tamara Mulkerin, Oakland, CA (US); Sivakumar Bhagavatula, Houston, TX (US)

(21) Appl. No.: 18/771,574

(22) Filed: Jul. 12, 2024

Related U.S. Application Data
(63) Continuation-in-part of application No. 18/351,334, filed on Jul. 12, 2023.

(51) Int. Cl. G06Q 30/018; G06Q 10/0633

(52) U.S. Cl. CPC G06Q 30/018; G06Q 10/0633

(57) ABSTRACT

A product carbon footprint (PCF) orchestrator can include a controller configured to generate a PCF determination package, where the PCF determination package includes a data contract and instructions that are customized for a customer system based on query information provided by a customer system, and where the data contract is configured to receive a plurality of inputs in the form of emission-related data. The controller can also be configured to send the PCF determination package to the customer system, where the emissions-related data remains with the customer system when the instructions are followed to generate the PCF results. The controller can further be configured to obtain PCF results and evaluate from the customer system after the customer system uses the data contract following the instructions of the PCF determination package. Emission data used by the customer system to generate the PCF results may not be accessed by the controller.

### CROSS-REFERENCE TO RELATED APPLICATIONS

This application is a continuation-in-part application of and claims priority to U.S. patent application Ser. No. 18/351,334, filed on Jul. 12, 2023, and entitled “SYSTEM AND METHOD FOR ORCHESTRATING THE DETERMINATION OF A PRODUCT CARBON FOOTPRINT”, the entire contents of which are hereby incorporated by reference herein.

### TECHNICAL FIELD

The present application is related to management of carbon footprints and, more particularly, to systems and methods for orchestrating and determining product carbon footprints (PCFs).

### BACKGROUND

Nearly all of today's products are associated with a value chain that involves a variety of participants ranging from producers to consumers. Certain of these participants may wish to focus their efforts on reducing the emissions associated with their products. Thus, it is presently recognized in many industries that it can be valuable to understand the emissions of not only an overall value chain, but also each segment/product within the value chain so that efforts can be focused on the most desirable emissions reduction opportunities.

Current efforts to understand emissions associated with value chains are complicated by the lack of a common language across industries and participants in value chains to certify and deliver reliable data that can help encourage and incentivize lower carbon outcomes. One challenge is that current offerings of data at a product level (e.g., a carbon footprint) generally rely on secondary estimated data and are fragmented, specific to one product in one industry, and require detailed studies of each facility which in addition to being time consuming is expensive. In other words, using typical approaches, a carbon footprint for a particular product in a certain industry may not be readily compared to the carbon footprint for a product in a different industry. Further, even within particular industries, there is little to no standardization for such measures.

Attempts to address this issue currently lack a common methodology to calculate a carbon footprint. Indeed, many carbon footprint figures are rough estimates and are limited to specific products or activities or are too general and leave out data at a facility level. Further, attempting to allocate emissions over multiple products produced by a single plant or facility can be difficult. Many approaches to such allocations from a single facility often involve a particular distribution of emissions across the different products without accounting for whether the product has a value or is waste, what the product requires for storage, delivery, and so on. Accordingly, a need exists for a solution that allows standardized calculations of product carbon footprints that can be used for comparisons across and between value chains and used to make informed decisions for targeting certain value chain segments for emissions reduction. A need also exists for methods of benchmarking and incentivizing based on these standardized approaches.

### SUMMARY

In general, in one aspect, the disclosure relates to a product carbon footprint (PCF) orchestrator that includes a controller that is configured to generate a PCF determination package, where the PCF determination package includes a data contract and instructions that are customized for a customer system of a customer based on query information provided by a customer system, where the data contract is configured to receive a plurality of inputs in the form of emission-related data, and where the data contract and instructions are configured to instruct the customer system as to how to format the emission-related data. The controller of the PCF orchestrator may also be configured to send the PCF determination package to the customer system, where the emissions-related data remains with the customer system when the instructions are followed to generate the PCF results. The controller of the PCF orchestrator may further be configured to obtain PCF results from the customer system after the customer system uses the data contract following the instructions of the PCF determination package. The controller of the PCF orchestrator may also be configured to evaluate the PCF results, where emission data used by the customer system to generate the PCF results are not accessed by the controller.

In another aspect, the disclosure relates to a computer-implemented method for orchestrating the determination of a product carbon footprint (PCF). The computer-implemented method can include generating, by a PCF orchestrator, a PCF determination package, where the PCF determination package includes a data contract and instructions that are customized for a customer system of a customer based on query information provided by a customer system, where the data contract is configured to receive a plurality of inputs in the form of emission-related data, and where the data contract and instructions are configured to instruct the customer system as to how to format the emission-related data. The computer-implemented method can also include sending, by the PCF orchestrator, the PCF determination package to the customer system, where the emissions-related data remains with the customer system when the instructions are followed to generate the PCF results. The computer-implemented method can further include obtaining, by the PCF orchestrator, PCF results from the customer system after the customer system uses the data contract following the instructions of the PCF determination package. The computer-implemented method can also include evaluating, by the PCF orchestrator, the PCF results, where emission data used by the customer system to generate the PCF results are not accessed by the controller PCF orchestrator.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a system for orchestrating the determination of PCFs according to certain example embodiments.

FIG. 2 shows a system diagram of a controller of the PCF orchestrator of FIG. 1 according to certain example embodiments.

FIG. 3 shows a computing device in accordance with certain example embodiments.

FIG. 4 shows a flowchart of a method for orchestrating the determination of PCFs according to certain example embodiments.

FIG. 5 shows a flowchart of a method for generating a PCF determination package according to certain example embodiments.

FIG. 6 shows a flowchart of a method for providing a data contract and accompanying instructions to a customer according to certain example embodiments.

FIG. 7 shows an example of a subsystem that includes data contract of a PCF determination package according to certain example embodiments.

FIGS. 8 through 12 show screenshots of various screens displayed on a user interface while orchestrating the determination of a PCF according to certain example embodiments.

FIG. 13 shows a graph with monthly PCF values by product for a corporate entity according to certain example embodiments.

FIGS. 14 through 16 show various flowcharts for implementing methodologies according to certain example embodiments.

FIG. 17 shows a flowchart of a workflow methodology according to certain example embodiments.

FIG. 18 shows a flowchart of another workflow methodology according to certain example embodiments.

FIG. 19 shows a flowchart of a methodology construction according to certain example embodiments.

FIG. 20 shows a flowchart of a workflow processing architecture according to certain example embodiments.

### DETAILED DESCRIPTION

The example embodiments discussed herein are directed to systems and methods for orchestrating the determination of PCFs (also sometimes called PCF values herein). Example embodiments can be used to orchestrate the determination of PCFs in one or more of any of a number of industries and/or for a customer functioning at any point along a supply chain. Examples of industries for which example embodiments can be used can include, but are not limited to, oil and gas (e.g., exploration, production, refining), chemical production and/or manufacturing, aquaculture, oceanography, and electric power.

Example embodiments can be used without a customer having to provide any of its data and/or the data of its suppliers to a third party. Example embodiments described herein can be designed to comply with certain standards and/or requirements. Examples of entities that set such standards and/or requirements can include, but are not limited to, the Environmental Protection Agency (EPA), the World Resources Institute (WRI), the European Union (EU), the Center For Resource Solutions (CRS), the Intergovernmental Panel on Climate Change (IPCC), and the International Standards Organization (ISO).

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure can be inferred to that component. Conversely, if a component in a figure is labeled but is not described, the description for such component can be substantially the same as the description for the corresponding component in another figure. The numbering scheme for the various components in the figures herein is such that each component is a three-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of systems for orchestrating the determination of PCFs will be described more fully hereinafter with reference to the accompanying drawings, in which example embodiments of systems for orchestrating the determination of PCFs are shown. Orchestrating the determination of PCFs may, however, be embodied in many different forms (including variations of a marine vessel with a 2-stage tank filling mechanism) and should not be construed as limited to the example embodiments set forth herein. Rather, these example embodiments are provided so that this disclosure will be thorough and complete, and will fully convey the scope of systems for orchestrating the determination of PCFs to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation unless explicitly stated, and they are not meant to limit embodiments of systems for orchestrating the determination of PCFs. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

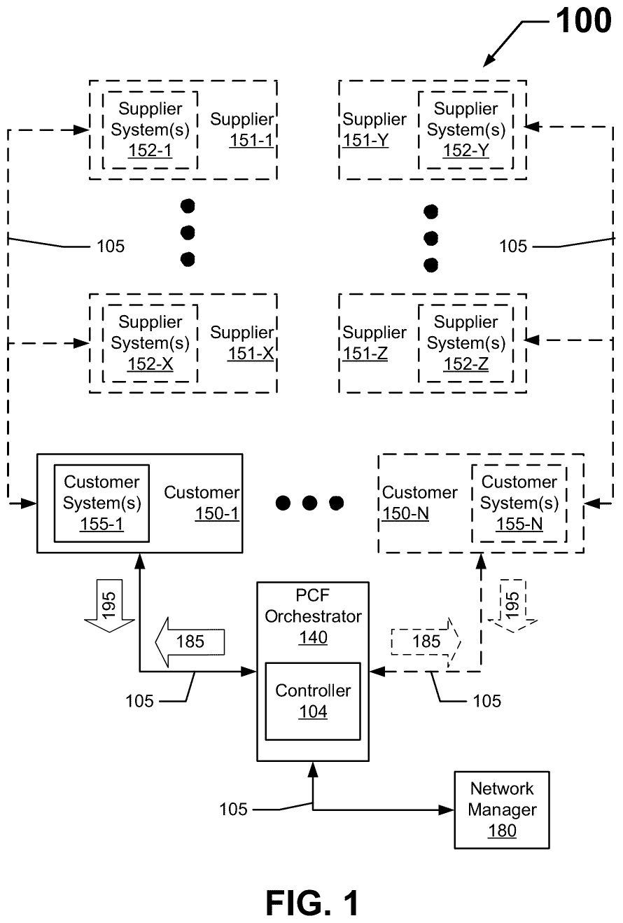

FIG. 1 shows a system 100 for orchestrating the determination of PCFs according to certain example embodiments. The system 100 includes multiple components. In this case, the system 100 includes a PCF orchestrator 140, a network manager 180, one or more customers 150 (including one or more associated customer systems 155), and one or more suppliers 151 (including one or more associated supplier systems 152). The system 100 also includes a number of communication links 105 to facilitate communication between various components within the system 100.

The system 100 can include any number of customers 150. In this example, there can be N customers 150 (customer 150-1 through customer 150-N). A customer 150 can provide goods and/or services. Determining the PCF of a customer 150 can be based, at least in part, on generating these goods and/or services. Each customer 150 can be an entity (e.g., a company, an organization, a group, an association) that is attempting to determine its PCF. A customer 150 can attempt to determine its PCF for mandatory (compliance) reporting, for voluntary disclosure, for budgeting purposes, and/or for some other reason. A customer 150 can be of any size (e.g., in terms of the number of employees, in terms of geographic location(s), in terms of the number of facilities) and/or any type (e.g., in terms of the industry served, in terms of the types of facilities, in terms of hierarchy (e.g., conglomerate, parent entity, subsidiary, stand-alone entity)).

A customer 150 can be an entity that is required to report and/or has decided to voluntarily report its PCF. The customer 150 can be a corporate entity. The customer 150 can be represented by one or more individuals (e.g., employees, officers) and/or other entities (e.g., an accounting firm, an auditing firm) when using some or all of the example PCF determination package 185. In some cases, a customer 150 in one situation can be a supplier 151 to another customer 150 in another situation.

A customer 150 can use one or more customer systems 155, which may include a display (e.g., a GUI). A customer system 155 of a customer 150 can interact with (e.g., send data to, obtain data from) the PCF orchestrator 140 (or portions thereof) and/or one or more suppliers 151 of the customer 150 via an application interface (similar to an application interface 226 discussed below) and using one or more communication links 105. Examples of a customer system 155 can include, but are not limited to, a cell phone, a laptop computer, a desktop computer, an electronic tablet, and a specialized handheld device. A customer system 155 can be considered a type of computer device, as discussed below with respect to FIG. 3.

In certain example embodiments, each customer 150 can use a customer system 155 to send PCF results 195 to the PCF orchestrator 140 using the communication links 105. The PCF results 195 are the output of the PCF determination package 185 received from the PCF orchestrator 140. The PCF results 195 can have any of a number of formats and/or sizes. For example, the PCF results 195 can be a single number (e.g., a single PCF value). As another example, the PCF results 195 can be a series of numbers (e.g., multiple PCF values). As yet another example, the PCF results 195 can be a full report with a summary, tables, and a detailed description. The PCF results 195 that are delivered to the PCF orchestrator 140 from a customer 150 may be identical to the output of the PCF determination package 185 that is received by the customer 150. Alternatively, the PCF results 195 that are delivered to the PCF orchestrator 140 from a customer 150 may be part of (e.g., a summary, selection portions) the output of the PCF determination package 185 that is received by the customer 150. In any case, the PCF orchestrator 140 can be configured to receive and analyze the PCF results 195 received from each customer 150.

Each customer 150 can have one or more optional suppliers 151. In alternative embodiments, a customer 150 can have no suppliers 151. A supplier 151 can provide goods and/or services to a customer 150, which in turn are used by the customer 150 to generate its own goods and/or services. The goods and/or services provided by a supplier 151 to a customer 150 can affect the PCF of the customer 150. As a result, certain data (e.g., energy usage, emission data) can be provided (using one or more communication links 105) by the supplier 151 to a customer 150 so that the data can be used to determine the PCF of the customer 150. In this case, customer 150-1 can have X suppliers 151 (supplier 151-1 through supplier 151-X). As another example, customer 150-N can have Y suppliers 151 (supplier 151-Y through supplier 151-Z). A supplier 151 can supply goods and/or services to more than one customer 150. In some cases, a supplier 151 to a customer 150 in one situation can itself be a customer 150 in another situation.

A supplier 151 can use and/or include one or more supplier systems 152, which may include a display (e.g., a GUI). For example, supplier 151-1 can use and/or include supplier system 152-1, supplier 151-X can use and/or include supplier system 152-X, supplier 151-Y, and can use and/or include supplier system 152-Y, and supplier 151-Z can use and/or include supplier system 152-Z. A supplier system 152 of a supplier 151 can interact with (e.g., send data to, obtain data from) one or more customer systems 155 of one or more customers 150 and/or one or more other supplier systems 152 of one or more other suppliers 151 of a customer 150 via an application interface (similar to an application interface 226 discussed below) and using one or more communication links 105. Examples of a supplier system 152 can include, but are not limited to, a cell phone, a laptop computer, a desktop computer, an electronic tablet, and a specialized handheld device. A supplier system 152 can be considered a type of computer device, as discussed below with respect to FIG. 3.

The network manager 180 of the system 100 can be configured to control and/or communicate with the PCF orchestrator 140. For example, the network manager 180 may be configured to provide updated instructions for the customers 150. As another example, the network manager 180 can facilitate communication between the PCF orchestrator 140 and one or more other PCF orchestrators that are communicating with other customers outside the system 100. In some cases, the network manager 180 can be or be controlled, in whole or in part, by a user. Examples of a user can include, but are not limited to, a business owner, a customer 150, a supplier 151, an auditor, a research scientist, an analyst, a compliance manager, an engineer, a company representative, an inspector, a consultant, a government representative, a regulator, a contractor, and a manufacturer's representative.

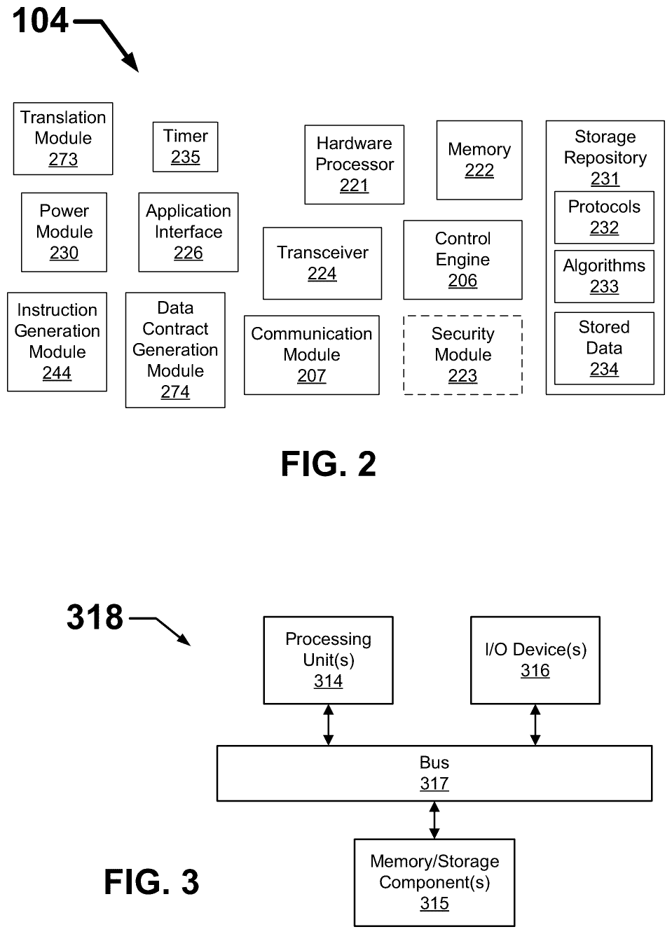

The network manager 180 may be substantially similar to some or all of the controller 104, as described below with respect to FIG. 2. For example, the network manager 180 may include a controller that has one or more components and/or similar functionality to some or all of the controller 104. Alternatively, the network manager 180 may include one or more of a number of features in addition to, or altered from, the features of the controller 104. As described herein, control and/or communication with the network manager 180 may include communicating with the PCF orchestrator 140 in the same system 100 and/or with one or more other PCF orchestrators in one or more other systems. In such a case, the network manager 180 may facilitate such control and/or communication. The network manager 180 may be called by other names, including but not limited to a master controller, a network controller, and an enterprise manager. The network manager 180 may be considered a type of computer device, as discussed below with respect to FIG. 3.

In certain example embodiments, the PCF orchestrator 140 sends a PCF determination package 185 to a customer system 155 of a customer 150, where the PCF determination package 185 can be generic for all customers 150. As discussed below, the PCF determination package 185 in such cases can be used to derive a data contract and accompanying instructions that are specific for a customer system 155 of a customer 150. In alternative embodiments, the PCF orchestrator 140 can be configured to receive query information (discussed below) from one or more of the customer systems 155 of the customers 150 using the communication links 105. Such query information can be used by the PCF orchestrator 140 to generate a PCF determination package 185, which is sent to one or more of the customer systems 155 of one or more of the customers 150 by the PCF orchestrator 140 using the communication links 105. In such a case, the PCF determination package 185 can include a data contract and associated instructions that are configured, once received by the customer system 155, by the PCF determination package 185 specifically for the customer system 155 of the customer 150 based on the query information. The data contract derived from the PCF determination package 185 can be designed to allow for standardization for how a PCF is calculated (or otherwise determined) across customers 150, industries, geographies, and/or any other factor that can categorize the emissions associated with a customer 150. The PCF determination package 185, including the instructions and the data contract, can be configured to reside on and operate within a customer system 155 of the customer 150. Alternatively, the instructions and the data contract derived from a PCF determination package 185 can be configured to be accessed (e.g., securely, non-securely) through a portal of a website.

The PCF determination package 185 generated by the PCF orchestrator 140 can be used to derive instructions and a data contract. The instructions generated by the PCF orchestrator 140 from the PCF determination package 185 can have any of a number of formats. For example, the instructions can be or include how to provide inputs to the data contract, the inputs required, the units and/or format of each of the inputs, how to use the data contract, frequently asked questions, help information, and a glossary.

The PCF determination package 185 provides a number of benefits. For example, the PCF determination package 185 can provide a value chain codified as workflow with a well-defined data contract. Specifically, the PCF determination package 185 can provide the data contract structures of a customer system 155 of a customer 150 a given value chain as a data contract with standardized segments and fields (e.g., hierarchical, geographic, industry-specific) required to represent and complete a calculation of a PCF. Such a data contract can include fields to allow customers 150 to indicate when primary data (i.e., data that comes directly from the customer system 155 of a customer 150) or secondary data (i.e., data that comes to the customer system 155 of a customer 150 from a supplier system 152 of a supplier 151) should be used for a segment, including the measurement type for the data.

The data contract can be configured in such a way that the customer 150 retains complete control of the data on the customer system 155 used to calculate (or otherwise determine) its PCF. For example, the data contract can be configured to receive inputs from a customer system 155 of a customer 150 and provide an output that is or includes the PCF of the customer 150. In some cases, the data contract of the PCF determination package 185 can include some validation algorithms that can determine if some of the data entered by a customer 150 was faulty, incomplete, or erroneous. When the PCF is output by the data contract, the customer system 155 of a customer 150 and/or the data contract of the PCF determination package 185 can send the output to the PCF orchestrator 140. The PCF orchestrator 140 can include one or more controllers 104. More details about the controller 104 are provided below with respect to FIG. 2. The controller 104 of the PCF orchestrator 140 can be considered a type of computer device, as discussed below with respect to FIG. 3.

The network manager 180 can communicate directly with the PCF orchestrator 140. The PCF orchestrator 140 can communicate directly with each of the customer systems 155 of the customers 150, including any associated customer systems 155. In some cases, the PCF orchestrator 140 may also communicate directly with one or more of the suppliers 151, including any associated supplier systems 152, of a customer 150. Further, each of the suppliers 151, including any associated supplier systems 152, can communicate directly with each other and/or with each of the customers 150, including any associated customer systems 155. In some cases, two or more of the customers 150, including any associated customer systems 155, can communicate directly with each other. Such communication can occur using the communication links 105.

Each communication link 105 can include wired (e.g., Class 1 electrical cables, Class 2 electrical cables, electrical connectors, Power Line Carrier, RS485) and/or wireless (e.g., Wi-Fi, Zigbee, visible light communication, cellular networking, satellite, Bluetooth, WirelessHART, ISA100) technology. A communication link 105 can be used for the transmission of signals (e.g., communication signals, control signals, data) between the customer systems 155, the network manager 180, the supplier systems 152, and the PCF orchestrator 140 (including portions thereof, such as the controller 104) in the system 100.

FIG. 2 shows a system diagram of a controller 104 of the PCF orchestrator 140 of FIG. 1 according to certain example embodiments. Referring to FIGS. 1 and 2, the controller 104 of FIG. 2 can include multiple components. For example, in this case, the controller 104 includes a control engine 206, an instruction generation module 244, a translation module 273, a data contract generation module 274, a communication module 207, a timer 235, a power module 230, a storage repository 231, a hardware processor 221, memory 222, a transceiver 224, an application interface 226, and a security module 223. The various components of the controller 104 may be centrally located. In addition, or in the alternative, some of the components of the controller 104 may be located remotely from (e.g., in the cloud, at an office building) one or more of the other components of the controller 104.

The components shown in FIG. 2 are not exhaustive, and in some embodiments, one or more of the components shown in FIG. 2 may not be included in the controller 104 of the PCF orchestrator 140. For example, if there are multiple PCF orchestrators 140 in a system (e.g., system 100), where each PCF orchestrator 140 has its own controller 104, then one controller 104 can be subservient to the other controller 104. In such cases, the subservient controller 104 can lack some of the components (e.g., an instruction generation module 244, a data contract generation module 274) and instead rely on the other controller 104 for the capabilities provided by those components.

The controller 104 performs a number of functions that may include receiving data, evaluating data, following protocols, running algorithms, receiving instructions, and sending instructions. A PCF orchestrator 140 can have a single controller 104 or multiple controllers 104. When there are multiple controllers 104 of a PCF orchestrator 140, each controller 104 can operate independently of each other. Alternatively, one or more of the controllers 104 in a PCF orchestrator 140 can work cooperatively with each other. As yet another alternative, one of the controllers 104 of a PCF orchestrator 140 can control some or all of one or more other controllers 104 of a PCF orchestrator 140.

The storage repository 231 of a controller 104 of a PCF orchestrator 140 may be a persistent storage device (or set of devices) that stores software and data used to assist the controller 104 in communicating with one or more other components of the PCF orchestrator 140 and/or other components of the system 100 (e.g., a customer system 155 of a customer 150, the network manager 180). In one or more example embodiments, the storage repository 231 stores one or more protocols 232, one or more algorithms 233, and stored data 234.

The protocols 232 of the storage repository 231 may be any procedures (e.g., a series of method steps) and/or other similar operational processes that the control engine 206 of the controller 104 follows based on certain conditions at a point in time. The protocols 232 may include any of a number of communication protocols that are used to send and/or obtain data between the controller 104 and other components of a system (e.g., system 100) or portion thereof (e.g., a customer system 155). Such protocols 232 used for communication may be a time-synchronized protocol. Examples of such time-synchronized protocols may include, but are not limited to, a highway addressable remote transducer (HART) protocol, a WirelessHART protocol, and an International Society of Automation (ISA) 100 protocol. In this way, one or more of the protocols 232 may provide a layer of security to the data transferred within a system or portion thereof (e.g., a customer system 155). Other protocols 232 used for communication may be associated with the use of Wi-Fi, Zigbee, visible light communication (VLC), cellular networking, BLE, UWB, and Bluetooth. One or more of the protocols 232 can be part of the instructions of the PCF determination package 185 delivered to a customer system 155 of a customer 150.

The algorithms 233 may be any formulas, mathematical models, forecasts, simulations, and/or other similar tools that the control engine 206 and/or other component of the controller 104 uses to reach a computational conclusion. For example, one or more algorithms 233 may be used, in conjunction with one or more protocols 232, to assist the controller 104 to generate and deploy a PCF determination package 185 to allow a customer system 155 of a customer 150 to determine its PCF. As another example, one or more algorithms 233 may be used, in conjunction with one or more protocols 232, to assist the controller 104 to receive and interpret a request or instruction from the network manager 180. As yet another example, one or more algorithms 233 may be used, in conjunction with one or more protocols 232, to assist the controller 104 to receive and interpret an output of a PCF determination package 185 from a customer system 155. One or more of the algorithms 233 can be part of the data contract of the PCF determination package 185 delivered to a customer system 155 of a customer 150.

Stored data 234 may be any data associated with the other components (e.g., a customer system 155, the network manager 180) of a system (e.g., system 100), relevant standards, relevant laws and regulations, the PCF results 195 provided by a customer system 155, threshold values, tables, results of previously run or calculated algorithms 233, updates to protocols 232, weighting factors, user preferences, and/or any other suitable data. Such data may be any type of data, including but not limited to historical data, present data, and future data (e.g., forecasts). The stored data 234 may be associated with some measurement of time derived, for example, from the timer 235.

Examples of a storage repository 231 may include, but are not limited to, a database (or a number of databases), a file system, cloud-based storage, a hard drive, flash memory, some other form of solid-state data storage, or any suitable combination thereof. The storage repository 231 may be located on multiple physical machines, each storing all or a portion of the protocols 232, the algorithms 233, and/or the stored data 234 according to some example embodiments. Each storage unit or device may be physically located in the same or in a different geographic location.

The storage repository 231 may be operatively connected to the control engine 206. In one or more example embodiments, the control engine 206 includes functionality to communicate with other components (if any) of the PCF orchestrator 140 and/or the other components (e.g., the network manager 180, the customer systems 155, another PCF orchestrator 140) of the system 100. More specifically, the control engine 206 sends information to and/or obtains information from the storage repository 231 in order to communicate with the various components of a PCF orchestrator 140 and/or the various components of the system 100. As discussed below, the storage repository 231 may also be operatively connected to the communication module 207 in certain example embodiments.

In certain example embodiments, the control engine 206 of the controller 104 controls the operation of one or more components (e.g., the communication module 207, the timer 235, the transceiver 224) of the controller 104. For example, the control engine 206 may activate the communication module 207 when the communication module 207 is in “sleep” mode and when the communication module 207 is needed to send data obtained from another component (e.g., a customer system 155) and/or another controller (e.g., a controller 104 of another PCF orchestrator 140) in the system 100. In addition, the control engine 206 of the controller 104 may control the operation of one or more other components (e.g., a controller 104 of another PCF orchestrator 140), or portions thereof, of the system 100.

In certain example embodiments, the control engine 206 of the controller 104 of a PCF orchestrator 140, using one or more protocols 232, one or more algorithms 233, and/or stored data 234, can be configured to coordinate with the data contract generation module 274 to generate the data contract that is sent to and used by a customer system 155 of a customer 150 to determine the PCF of the customer 150. In addition, or in the alternative, the control engine 206 of the controller 104 of a PCF orchestrator 140, using one or more protocols 232, one or more algorithms 233, and/or stored data 234, can be configured to coordinate with the instruction generation module 244 to generate the instructions that are sent to and used by a customer system 155 of a customer 150 to use the data contract for determining the PCF of the customer 150.

In addition, or in the alternative, the control engine 206 of the controller 104 of a PCF orchestrator 140, using one or more protocols 232, one or more algorithms 233, and/or stored data 234, can be configured to coordinate with the data contract module 274 to generate a data contract for a customer system 155 of a customer 150. In addition, or in the alternative, the control engine 206 of the controller 104 of a PCF orchestrator 140, using one or more protocols 232, one or more algorithms 233, and/or stored data 234, can be configured to use the output of the data contract from a customer system 155 of a customer 150 for trending, tracking, improving one or more algorithms 233, changing one or more protocols 232, and/or changing the PCF determination package 185.

In addition, or in the alternative, the control engine 206 of the controller 104 of a PCF orchestrator 140, using one or more protocols 232, one or more algorithms 233, and/or stored data 234, may be configured to generate benchmarks using at least some of the output of the data contract from a customer system 155 of a customer 150. Further, the control engine 206 of the controller 104 of a PCF orchestrator 140, using one or more protocols 232, one or more algorithms 233, and/or stored data 234, may be configured to generate an amount of carbon credits (e.g., in excess, in deficit) based on comparing the PCF value of a customer 150 (including one or more suppliers 151 thereof) to one or more of the benchmarks generated by the control engine. In some cases, the control engine 206 of the controller 104 of a PCF orchestrator 140, using one or more protocols 232, one or more algorithms 233, and/or stored data 234, may be configured to generate one or more other benchmarks (e.g., carbon intensity) for variables associated with the PCF value of a customer 150 and/or one or more of its suppliers 151.

The control engine 206 may generate and process data associated with control, communication, and/or other signals sent to and/or obtained from another component (e.g., a controller 104 of another PCF orchestrator 140, the network manager 180, a customer system 155) of the system 100. In certain embodiments, the control engine 206 of the controller 104 may communicate with one or more components of a system external to the system 100. For example, the control engine 206 may interact with a regulatory agency and/or compliance group to receive the latest regulations, requirements, and other information associated with PCFs.

The control engine 206 of the controller 104, through the use of one or more protocols 232 and/or algorithms 233, may implement machine learning as a way to evolve over time with new data and associated changes that may result from the new data. The control engine 206 may use, for example, supervised learning, unsupervised learning, semi-supervised learning, and/or reinforcement learning, as those terms are known in the art of machine learning. In this case, these types of machine learning are effective with sufficient data (e.g., measurements from sensor devices, emissions data obtained from a customer system 155 and/or a supplier system 152) and use of algorithms 233 and/or protocols 232 that automatically build mathematical models using sample data-also known as “training data”.

In this way, for example, the PCF orchestrator 140 may translate the code embodied in the methodology definition of the PCF orchestrator 140 to the data structures and/or code on the target customer system 155 using data and language elements native to that customer system 155. In this way, the PCF orchestrator 140 may not require special software to reside and function on the customer system 155. Rather, the PCF orchestrator 140, by way of the learning protocols 232 and/or algorithms 233, uses features native to the customer system 155 to execute the methodology with the permission of the customer system 155. These learning protocols 232 and/or algorithms 233 may be used to match information from a customer system environment that is known (e.g., previously observed with the same or a different customer system 155) or unknown to the data contract in the methodology. Using this flexibility allowed by the learning protocols 232 and/or algorithms 233, the PCF orchestrator 140 may scale to disparate vendor solutions used within various customer systems 155 and ‘build’ customized data contracts and instructions to translate between those customer systems 155 and the data contract for the methodology. The learning algorithms 233 may use or include large language models (LLM) to implement unique classification/semantic matching properties that may assist in the development of customized data contracts and/or instructions for a customer system 155.

The learning protocols 232 and/or algorithms 233 that may be used and trained by the control engine 206 may include, but are not limited to, instance-based learning algorithms, artificial neural network algorithms, deep learning algorithms, and ensemble algorithms. Instance-based learning algorithms typically build up a database of example data and compare new data to the database using a similarity measure in order to find the best match and make a prediction. For this reason, instance-based methods are also called winner-take-all methods and memory-based learning. Focus may be put on the representation of the stored instances and similarity measures used between instances. Instance-based algorithms may be computationally expensive for very large datasets since they save all training instances/data points and are sensitive to data noise.

Artificial neural networks may be fairly similar to the human brain. For example, artificial neural networks may be made up of artificial neurons, take in multiple inputs, and produce specific outputs. Artificial neural networks may be an enormous subfield comprised of a large number of neural network architectures and hundreds of algorithms and variations for different types of problems. Artificial neural networks may be biologically inspired computational simulations for certain specific tasks like clustering, classification, or pattern recognition.

Deep learning algorithms may be a modern update to artificial neural networks by building much larger and more complex neural networks. With deep learning, many methods may be applied to very large datasets. Various architectures may be applied for deep learning algorithms. Deep learning may have a high computational cost because much of its development requires advanced processing, storage hardware, and ML platforms/APIs.

Ensemble algorithm methods may be models composed of multiple weaker models that are independently trained and whose predictions are combined in some way to make the overall prediction. Various combination techniques (e.g., averaging, max voting, bagging/bootstrapping (sampling subsets of original complete dataset), boosting) may be applied. Unlike other standard ensemble methods where models are trained in isolation, the boosting technique may employ an iterative approach, training models in succession, with each new model being trained to correct the errors made by the previous ones. Models may be added sequentially until no further improvements may be made.

In certain example embodiments, the control engine 206 may include an interface that enables the control engine 206 to communicate with another component (e.g., another controller 104 of another PCF orchestrator 140, the network manager 180, a customer system 155) of the system 100. For example, if a controller 104 of another PCF orchestrator 140 operates under IEC Standard 62386, then the controller 104 of the other PCF orchestrator 140 may have a serial communication interface that will transfer data to the controller 104. Such an interface may operate in conjunction with, or independently of, the protocols 232 used to communicate between the controller 104 and the other components of the system 100.

The control engine 206 (or other components of the controller 104) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The instruction generation module 244 of the controller 104 of a PCF orchestrator 140 may be configured to generate and/or maintain (e.g., revise as necessary) the instructions of the PCF determination package 185. The instructions can be used to inform a customer system 155 of a customer 150 as to how to properly use the data contract of the PCF determination package 185 so that the PCF of the customer can be determined. In some cases, the instruction generation module 244 may be configured to acquire data from other sources (e.g., regulatory authorities, statues, voluntary market organizers) external to the PCF orchestrator 140 to generate and/or update instructions. The instruction generation module 244 can be configured to make some or all of the instructions interactive with the data contract of the PCF determination package 185. For example, the instructions generated by the instruction generation module 244 can be configured to inform a customer system 155 of a customer 150 in real time that additional information is needed, the format required for certain data being entered, that data provided is outdated, etc.

In certain example embodiments, the instructions generated by the instruction generation module 244 can be configured to instruct a customer 150 (including an associated customer system 155) to use the data contract so that a PCF for the customer 150 can be determined. The instruction generation module 244 can also be configured to update or revised instructions based on, for example, feedback from a customer 150, changes in applicable laws or regulations, changes in voluntary markets, changes to the data contract derived from the PCF determination package 185, etc.

The instructions generated by the instruction generation module 244 can be tailored for a customer system 155 of a particular customer 150. In alternative embodiments, the instructions generated by the instruction generation module 244 can be tailored for customer systems 155 of multiple customers 150 that are part of a particular group (e.g., based on industry, based on geography, based on types of facilities, based on number of employees, based on revenues). The instruction generation module 244 can use one or more algorithms 233, one or more protocols 232, and/or stored data 234 to generate and/or modify the instructions.

The data contract generation module 274 of a PCF orchestrator 140 may be configured to generate and/or modify the data contract used by a customer system 155 of a customer 150 to determine the PCF of the customer 150. The data contract generated by the data contract generation module 274 can be derived from the PCF determination package 185 and can be tailored for a particular customer 150. In alternative embodiments, the data contract generated by the data contract generation module 274 can be tailored for the customer systems 155 of multiple customers 150 that are part of a particular group (e.g., based on industry, based on geography, based on types of facilities, based on number of employees, based on revenues). The data contract generation module 274 can use one or more algorithms 233, one or more protocols 232, and/or stored data 234 to generate and/or modify a data contract for the PCF orchestrator 140.

The data contract module 274 can generate the data contract based on information provided by the customer system 155 of a customer 150. Such information can be or include, but is not limited to, business practices of the customer 150, suppliers 151 of the customer 150, industry of the customer 150, products and/or services provided by the customer 150, products and/or services received by the customer 150, and geographic locations of the customer 150 and/or suppliers 151. The data contract module 274 can use one or more algorithms 233, one or more protocols 232, and/or stored data 234 to generate a data contract for the customer system 155 of a customer 150.

The translation module 273 of a PCF orchestrator 140 may be configured to provide a data processing framework for the PCF determination package 185 and a derivative data contract. Specifically, the translation module 273 can translate data received from a customer system 155 of a customer 150 and/or a supplier system 152 of an associated supplier 151 that is in a format that is incompatible with the data contract into a format that is compatible with the data contract. The translation module 273 can accomplish this task by using, for example, scripts in different languages to put the data into a format understood by the data contract.

The communication module 207 of the controller 104 determines and implements the communication protocol (e.g., from the protocols 232 of the storage repository 231) that is used when the control engine 206 communicates with (e.g., sends signals to, obtains signals from) the other components (e.g., the network manager 180, a customer system 155, another PCF orchestrator 140) of the system 100. In some cases, the communication module 207 accesses the stored data 234 to determine which communication protocol is used to communicate with another component of the system 100. In addition, the communication module 207 may identify and/or interpret the communication protocol of a communication obtained by the controller 104 so that the control engine 206 may interpret the communication. The communication module 207 may also provide one or more of a number of other services with respect to data sent from and obtained by the controller 104. Such services may include, but are not limited to, data packet routing information and procedures to follow in the event of data interruption.

The timer 235 of the controller 104 may track clock time, intervals of time, an amount of time, and/or any other measure of time. The timer 235 may also count the number of occurrences of an event, whether with or without respect to time. Alternatively, the control engine 206 may perform a counting function. The timer 235 is able to track multiple time measurements and/or count multiple occurrences concurrently. The timer 235 may track time periods based on an instruction obtained from the control engine 206, based on an instruction obtained from the network manager 180, based on an instruction programmed in the software for the controller 104, based on some other condition (e.g., the occurrence of an event) or from some other component, or from any combination thereof. In certain example embodiments, the timer 235 may provide a time stamp for each packet of data obtained from another component (e.g., a sensor device) of the system 100.

The power module 230 of the controller 104 obtains power from a power supply (e.g., AC mains, a battery) and manipulates (e.g., transforms, rectifies, inverts) that power to provide the manipulated power to one or more other components (e.g., the timer 235, the control engine 206) of the controller 104, where the manipulated power is of a type (e.g., alternating current, direct current) and level (e.g., 12V, 24V, 120V) that may be used by the other components of the controller 104.

The power module 230 may include one or more of a number of single or multiple discrete components (e.g., transistor, diode, resistor, transformer) and/or a microprocessor. The power module 230 may include a printed circuit board, upon which the microprocessor and/or one or more discrete components are positioned. In addition, or in the alternative, the power module 230 may be a source of power in itself to provide signals to the other components of the controller 104. For example, the power module 230 may be or include an energy storage device (e.g., a battery). As another example, the power module 230 may be or include a localized photovoltaic power system.

The hardware processor 221 of the controller 104 executes software, algorithms (e.g., algorithms 233), and firmware in accordance with one or more example embodiments. Specifically, the hardware processor 221 may execute software on the control engine 206 or any other portion of the controller 104, as well as software used by the customer systems 155, the network manager 180, and/or other components of the system 100. The hardware processor 221 may be an integrated circuit, a central processing unit, a multi-core processing chip, SoC, a multi-chip module including multiple multi-core processing chips, or other hardware processor in one or more example embodiments. The hardware processor 221 may be known by other names, including but not limited to a computer processor, a microprocessor, and a multi-core processor. In one or more example embodiments, the hardware processor 221 executes software instructions stored in memory 222. The memory 222 includes one or more cache memories, main memory, and/or any other suitable type of memory. The memory 222 may include volatile and/or non-volatile memory. The memory 222 may be discretely located within the controller 104 relative to the hardware processor 221. In certain configurations, the memory 222 may be integrated with the hardware processor 221.

In certain example embodiments, the controller 104 does not include a hardware processor 221. In such a case, the controller 104 may include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices may be used in conjunction with one or more hardware processors 221.

The transceiver 224 of the controller 104 may send and/or obtain control and/or communication signals. Specifically, the transceiver 224 may be used to transfer data between the controller 104 and the other components (e.g., sensor devices) of the PCF orchestrator 140 and the other components (e.g., the network manager 180, a customer system 155, another PCF orchestrator 140) of the system 100. The transceiver 224 may use wired and/or wireless technology. The transceiver 224 may be configured in such a way that the control and/or communication signals sent and/or obtained by the transceiver 224 may be obtained and/or sent by another transceiver that is part of another component (e.g., the network manager 180, a customer system 155, another PCF orchestrator 140) of the system 100. The transceiver 224 may send and/or obtain any of a number of signal types, including but not limited to radio frequency signals.

When the transceiver 224 uses wireless technology, any type of wireless technology may be used by the transceiver 224 in sending and obtaining signals. Such wireless technology may include, but is not limited to, Wi-Fi, Zigbee, VLC, cellular networking, BLE, UWB, and Bluetooth. The transceiver 224 may use one or more of any number of suitable communication protocols (e.g., ISA100, HART) when sending and/or obtaining signals.

Optionally, in one or more example embodiments, the security module 223 secures interactions between the controller 104 and the other components (e.g., the network manager 180, a customer system 155, another PCF orchestrator 140) of the system 100. More specifically, the security module 223 authenticates communication from software based on security keys verifying the identity of the source of the communication. For example, user software may be associated with a security key enabling the software of a customer system 155 to interact with the controller 104. Further, the security module 223 may restrict receipt of information, requests for information, and/or access to information.

The other components (if any) of the PCF orchestrator 140 and the other components (e.g., the network manager 180, a customer system 155, another PCF orchestrator 140) of the system 100 may interact with the controller 104 of the PCF orchestrator 140 using the application interface 226. Specifically, the application interface 226 of the controller 104 obtains data (e.g., information, communications, instructions, updates to firmware, updates to software) from and sends data (e.g., information, communications, instructions, updates to firmware, updates to software) to the other components of the PCF orchestrator 140 and the other components (e.g., the network manager 180, a customer system 155, another PCF orchestrator 140) of the system 100.

Examples of an application interface 226 may be or include, but are not limited to, an application programming interface, a web service, a data protocol adapter, some other hardware and/or software, or any suitable combination thereof. Similarly, other components of the PCF orchestrator 140 and the other components (e.g., the network manager 180, a customer system 155, another PCF orchestrator 140) of the system 100 may include an interface (similar to the application interface 226 of the controller 104) to obtain data from and send data to the controller 104 in certain example embodiments.

FIG. 3 illustrates one embodiment of a computing device 318 that implements one or more of the various techniques described herein, and which is representative, in whole or in part, of the elements described herein pursuant to certain example embodiments. For example, a controller 104 (including components thereof, such as a control engine 206, a hardware processor 221, a storage repository 231, a power module 230, and a transceiver 224) may be considered a computing device 318. Computing device 318 is one example of a computing device and is not intended to suggest any limitation as to scope of use or functionality of the computing device and/or its possible architectures. Neither should the computing device 318 be interpreted as having any dependency or requirement relating to any one or combination of components illustrated in the example computing device 318.

The computing device 318 includes one or more processors or processing units 314, one or more memory/storage components 315, one or more input/output (I/O) devices 316, and a bus 317 that allows the various components and devices to communicate with one another. The bus 317 represents one or more of any of several types of bus structures, including a memory bus or memory controller, a peripheral bus, an accelerated graphics port, and a processor or local bus using any of a variety of bus architectures. The bus 317 may include wired and/or wireless buses.

The memory/storage component 315 represents one or more computer storage media. The memory/storage component 315 includes volatile media (such as random access memory (RAM)) and/or nonvolatile media (such as read only memory (ROM), flash memory, optical disks, magnetic disks, and so forth). The memory/storage component 315 includes fixed media (e.g., RAM, ROM, a fixed hard drive, etc.) as well as removable media (e.g., a flash memory drive, a removable hard drive, an optical disk, and so forth).

One or more I/O devices 316 allow a customer system 155 of a customer 150 to enter commands and information to the computing device 318, and also allow information to be presented to the customer 150 (including an associated customer system 155) and/or other components or devices. Examples of input devices 316 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 318 (also sometimes called a computer system 318) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 318 includes at least the minimal processing, input, and/or output means necessary to practice one or more embodiments.

Further, those skilled in the art will appreciate that one or more elements of the aforementioned computer device 318 is located at a remote location and connected to the other elements over a network in certain example embodiments. Further, one or more embodiments can be implemented on a distributed system having one or more nodes, where each portion of the implementation (e.g., a PCF orchestrator 140) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

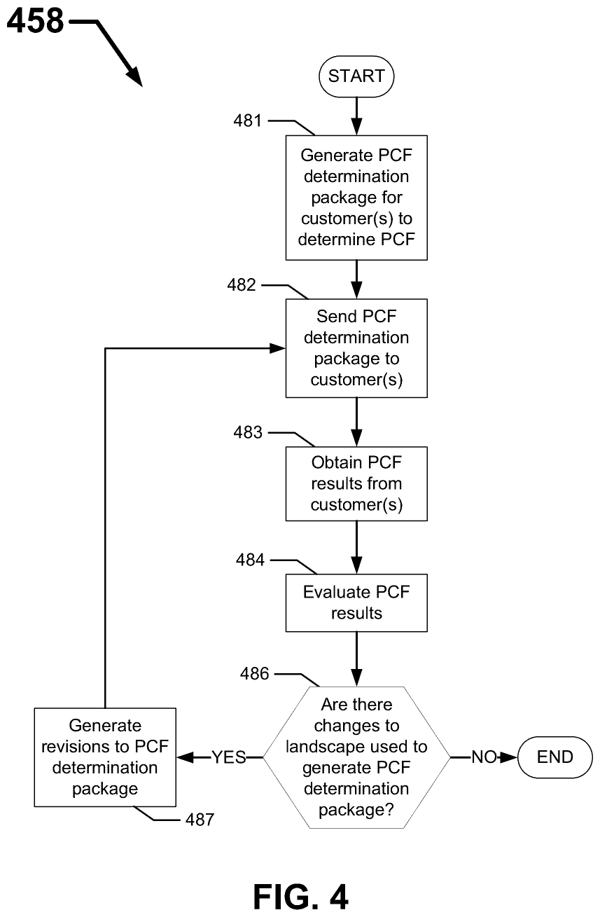

FIG. 4 shows a flowchart 458 of a method for orchestrating the determination of PCFs according to certain example embodiments. While the various steps in this flowchart 458 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 4 may be included in performing this method. Accordingly, the specific arrangement of steps should not be construed as limiting the scope. Further, a particular computing device, such as the computing device 318 discussed above with respect to FIG. 3, may be used to perform or facilitate performance of one or more of the steps (or portions thereof) for the method shown in FIG. 4 in certain example embodiments. Any of the functions (or portions thereof) performed below by a controller 104 may involve the use of one or more protocols 232, one or more algorithms 233, and/or stored data 234 stored in a storage repository 231. In some cases, one or more of the various steps in the method of FIG. 4 can be performed automatically, as by a controller 104 of a PCF orchestrator 140.

The method shown in FIG. 4 is merely an example that may be performed by using an example system described herein. In other words, systems for orchestrating the determination of PCFs may perform other functions using other methods in addition to and/or aside from those shown in FIG. 4. Referring to FIGS. 1 through 4, the method shown in the flowchart 458 of FIG. 4 begins at the START step and proceeds to step 481, where a PCF determination package 185 is generated for the customer systems 155 of one or more customers 150 to determine a PCF. The PCF determination package 185 can be generated by the controller 104 (or portions thereof, such as the control engine 206, the instruction generation module 244, and the data contract generation module 274) of the PCF orchestrator 140 using one or more algorithms 233, one or more protocols 232, and/or stored data 234.

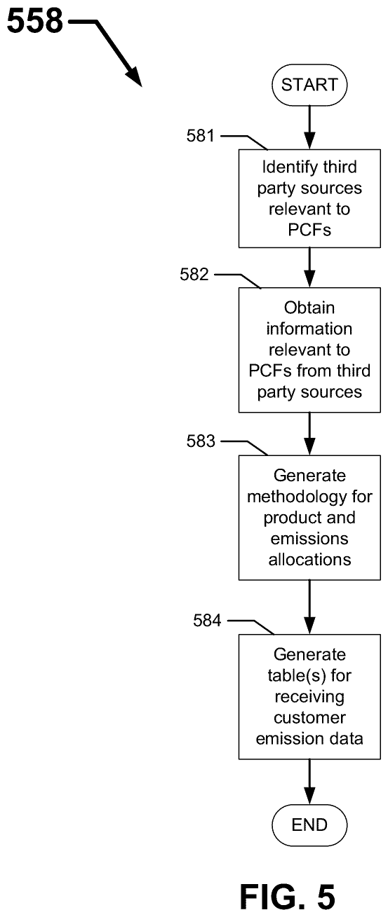

As discussed above, the PCF determination package 185 can be or include instructions (generated by the instruction generation module 244 of the controller 104 of the PCF orchestrator 140) and a data contract (generated by the data contract generation module 274 of the controller 104 of the PCF orchestrator 140). The instructions and/or the data contract of the PCF determination package 185 can be specific for a particular customer 150 (and in particular a customer system 155), tailored for the customer systems 155 of multiple customers 150 that are part of a particular group, or generally applicable for the customer systems 155 of all customers 150. An example of a method for generating a PCF determination package is shown in FIG. 5 below. As defined herein, instructions are protocols and/or algorithms that are followed by a customer system 155 without the direct involvement of a human being (e.g., a customer 150). Similarly, as defined herein, data contracts are schemas, protocols, and the like that are directed to and followed by a customer system 155 without the direct involvement of a human being (e.g., a customer 150).

In some cases, the data contact is initially set in a general manner based on general information (e.g., industry in which the customer 150 participates) received by the PCF orchestrator 140. In such a case, the instructions of the PCF determination package 185 may be generic or not developed (e.g., tailored for the customer system 155) until the data contract is received by the customer system 155, at which point the instructions are developed specifically for the customer system 155 based on additional inputs (e.g., data sources, software used by the customer system 155) received by the PCF determination package 185 while residing on the customer system 155.

In step 482, the PCF determination package 185 is sent to the one or more customers 150. The PCF determination package 185 can be delivered to the one or more customers 150 (including associated customer systems 155) using one or more of the communication links 105. The PCF determination package 185 can be sent by the controller 104 of the PCF orchestrator 140 using the communication module 207 and/or the application interface 226. The PCF determination package 185 can be received by a customer system 155 of each of the customers 150 that are recipients of the PCF determination package 185. In certain example embodiments, the customer system 155 of each of the customers 150 that are recipients of the PCF determination package 185 can send a communication, using one or more of the communication links 105, to the controller 104 of the PCF orchestrator 140 to confirm that the PCF determination package 185 was received.

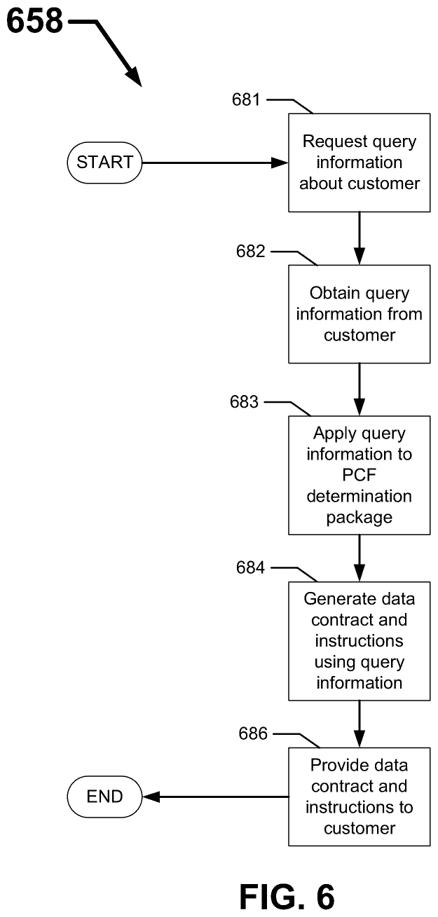

When the PCF determination package 185 is generally applicable for all customers 150 (e.g., for all industries, for all geographies), a data contract can be generated and provided for each particular customer 150. In such cases, for each customer 150 (including any associated customer systems 155, suppliers 151, and/or associated supplier systems 152) that receives the PCF determination package 185, a data contract (including associated instructions), tailored for each customer 150 (including any customer systems 155, associated suppliers 151, and/or associated supplier systems 152), is derived from the PCF determination package 185. An example of a method for providing a data contract and corresponding instructions is shown below with respect to FIG. 6. A data contract can describe a data that is generalized for customers 150. In other words, the data contract creates a framework for consistent language across all customers 150. A data contract can allow a calculation to work in proper context and with correct assumptions about the data.

The data contract may include one or more tables (or portions thereof) from the PCF determination package 185. In such cases, instructions that accompany the data contract may guide a customer 150 (including an associated customer system 155) as to how to provide the information that fills the tables of the data contract. Alternatively, the instructions may automatically seek the information from data sources within the customer system 155 to fill the tables of the data contract. If information (e.g., certain types of emissions data) for a table in a data contract is not available to the customer 150, the PCF determination package 185 can include default values (e.g., industry averages) and/or benchmarks (e.g., industry standards, internal goals or targets, averages or targets based on prior performance or recent capital expenditures) that can be used in lieu of actual data. Some or all of such default values and/or benchmarks may be generated by the controller 104 of the PCF orchestrator 140 using one or more algorithms 233, one or more protocols 232, and/or stored data 234. Alternatively, some or all of such default values and/or benchmarks may be received, directly or indirectly, by the controller 104 of the PCF orchestrator 140 from a third party (e.g., the network manager 180, a customer 150, a government entity).

When the tables in the data contract are filled with data provided by the customer 150 (including associated customer systems 155, suppliers 151, and/or associated supplier systems 152), one or more allocations (e.g., emissions allocations, production allocations) can be applied. The allocations can apportion some of the emission data input into the tables so that the proper amount of a total value is attributed to the PCF results 195. Such allocations can be part of the data contract, as discussed below with respect to FIG. 6. These allocations, along with any other supporting inputs, can be used to generate the PCF results 195.

In step 483, the PCF results 195 are obtained from each of the customers 150. As used herein, the term “obtaining” may include receiving, retrieving, accessing, generating, etc. or any other manner of obtaining the results or other information. The PCF results 195 can be the output of the data contract yielding the PCF of the customer 150. The PCF results 195 can be sent by a customer system 155 of each of the customers 150 using one or more of the communication links. The PCF results 195 can be obtained by the PCF orchestrator 140. The PCF results 195 that are delivered to the PCF orchestrator 140 from a customer 150 may be identical to the output of the PCF determination package 185 that is received by the customer 150. Alternatively, the PCF results 195 that are delivered to the PCF orchestrator 140 from a customer 150 may be part of (e.g., a summary, selection portions) the output of the PCF determination package 185 that is received by the customer 150. In certain example embodiments, the controller 104 of the PCF orchestrator 140 can send a communication, using one or more of the communication links 105, to the customer system 155 of each of the customers 150 to confirm that the PCF results 195 were obtained.

In step 484, the PCF results 195 are evaluated. The PCF results 195 can be evaluated by the controller 104 (or portions thereof, such as the control engine 206, the instruction generation module 244, and the data contract generation module 274) of the PCF orchestrator 140 using one or more algorithms 233, one or more protocols 232, and/or stored data 234. The PCF orchestrator 140 can be configured to interpret the PCF results 195 and use the PCF results 195 in one or more analyses, whether for the particular customer 150 that sent the PCF results 195, a particular group of customers 150, in an overall analysis, or for some other scope of customers 150, regardless of the format and/or size of the PCF results 195.

In step 486, a determination is made as to whether there are changes to the landscape used to generate the PCF determination package 185. In certain example embodiments, the controller 104 (or portions thereof) of the PCF orchestrator 140 can make the determination as to whether there are changes to the landscape used to generate the PCF determination package 185. In such a case, the control engine 206 can use the instruction generation module 244, the data contract generation module 274, one or more algorithms 233, one or more protocols 232, and/or stored data 234 to make the determination. In addition, or in the alternative, the determination can be made by, or can be based on information provided by, the network manager 180 (e.g., a user) communicating with the controller 104 of the PCF orchestrator 140. In addition, or in the alternative, the determination can be made by, or can be based on information provided by, one or more of the customers 150.

In certain example embodiments, the determination as to whether there are changes to the landscape used to generate the PCF determination package 185 can be made autonomously and without any human interaction or intervention. Changes to the landscape used to generate the PCF determination package 185 can be based on one or more of a number of factors, including but not limited to a change in a law, an addition of a law, a change in a regulation, an addition of a regulation, the development of an emission market as a commodity market, changes in existing technology, introduction of new technology, a change (e.g., a sale, a merger, an expansion, development of new goals) in the business of a customer 150, and evaluating the PCF results 195 (as in step 486). If there are changes to the landscape used to generate the PCF determination package 185, then the process proceeds to step 487. If there are no changes to the landscape used to generate the PCF determination package 185, then the process proceeds to the END step.

In step 487, revisions to the PCF determination package 185 are generated. The PCF determination package 185 can be revised by the controller 104 (or portions thereof, such as the control engine 206, the instruction generation module 244, and the data contract generation module 274) of the PCF orchestrator 140 using one or more algorithms 233, one or more protocols 232, and/or stored data 234. Revisions to the PCF determination package 185 can be generated based on the changes to the landscape used to generate the PCF determination package 185, as discussed in step 484. When step 487 is complete, the process reverts to step 482.

FIG. 5 shows a flowchart 558 of a method for generating a PCF determination package 185 according to certain example embodiments. While the various steps in this flowchart 558 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 5 may be included in performing this method. Accordingly, the specific arrangement of steps should not be construed as limiting the scope. Further, a particular computing device, such as the computing device 318 discussed above with respect to FIG. 3, may be used to perform or facilitate performance of one or more of the steps (or portions thereof) for the method shown in FIG. 5 in certain example embodiments. Any of the functions (or portions thereof) performed below by a controller 104 may involve the use of one or more protocols 232, one or more algorithms 233, and/or stored data 234 stored in a storage repository 231. In some cases, one or more of the various steps in the method of FIG. 5 can be performed automatically, as by a controller 104 of a PCF orchestrator 140. In certain example embodiments, some or all of the steps expressly or impliedly captured in the flowchart 558 of FIG. 5 may be performed on a customer system 155 of a customer 150.

The method shown in FIG. 5 is merely an example that may be performed by using an example system described herein. In other words, systems for generating a PCF determination package may perform other functions using other methods in addition to and/or aside from those shown in FIG. 5. Referring to FIGS. 1 through 5, the method shown in the flowchart 558 of FIG. 5 begins at the START step and proceeds to step 581, where third party sources relevant to PCFs are identified. A third party source can be or include a website that describes government rules and/or regulations about or related to PCFs, a website that describes industry standards and/or guidelines about or related to PCFs, a website that tracks data and/or statistics about PCF programs and/or participants, a website that describes voluntary PCF programs, and PCF relevant documents that are digitally scanned in a readable format.

A third party source can be identified by the controller 104 of the PCF orchestrator 140 (e.g., using one or more protocols 232), by the network manager 180, by one or more customers 150 (including an associated customer system 155), by one or more suppliers 151, and/or by some other entity. When a third party source is identified by the controller 104 of the PCF orchestrator 140, the controller 104 can perform the identification using the application interface 226, the communication module 207, one or more algorithms 233, one or more protocols 232, and/or stored data 234. In some cases, the controller 104 (or portion thereof) of the PCF orchestrator 140 can use one or more protocols 232 to authenticate and/or confirm the validity of a third party source before using information available through the third party source.

In step 582, information relevant to PCFs is obtained from the third party sources. The information relevant to PCFs obtained from a third party source can be identified by the controller 104 of the PCF orchestrator 140 (e.g., using one or more protocols 232), by the network manager 180, by one or more customers 150, by one or more suppliers 151, and/or by some other entity. When information relevant to PCFs is obtained by the controller 104 of the PCF orchestrator 140, the controller 104 can perform the obtaining using the application interface 226, the communication module 207, one or more algorithms 233, one or more protocols 232, and/or stored data 234. In some cases, the controller 104 (or portion thereof) of the PCF orchestrator 140 can use one or more protocols 232 to authenticate and/or confirm the validity of the information before obtaining the information from the third party source.

In step 583, a methodology for product and emissions allocations is generated. A methodology for product allocations is directed to defining how emissions-related data is allocated over multiple products that are consumed, manufactured, assembled, and/or otherwise used by a customer 150 and/or an associated supplier 151. A methodology for emissions allocations is directed to defining how emissions-related data is allocated over one or more processes that are that are consumed, manufactured, assembled, and/or otherwise used by a customer 150 and/or an associated supplier 151. The methodology can be tied to a data contract that describes the nature of the inputs and outputs. The methodology may be (or be used to generate) the data contact and/or the instructions. One or more allocations can be based, in part, on some of the information obtained in step 582.

A methodology can be generated by the controller 104 of the PCF orchestrator 140 (e.g., using one or more protocols 232 and/or one or more algorithms 233), by the network manager 180, by one or more customers 150, by one or more suppliers 151, and/or by some other entity. When a methodology is generated by the controller 104 of the PCF orchestrator 140, the controller 104 can generate the methodology using the application interface 226, the communication module 207, one or more algorithms 233, one or more protocols 232, and/or stored data 234. In some cases, the controller 104 (or portion thereof) of the PCF orchestrator 140 can use one or more protocols 232 to authenticate and/or confirm the validity of a methodology.

In some cases, the methodology (and associated instructions) is generated by information loaded on or about the customer system 155 being obtained. For example, information about the software (e.g., manufacturer, product, version) loaded on the customer system 155 for generating a PCF value may be obtained and used, at least in part, to generate the methodology (and customized instructions) for the customer system 155. As another example, information (e.g., types of data, frequency of data, frequency of transmission to the customer system 155, location, units of measure) about the various data sources used to directly or indirectly calculate the PCF value may be obtained and used, at least in part, to generate the methodology (and customized instructions) for the customer system 155.

In step 584, one or more tables for receiving emission data for a customer 150 can be generated. Each table can be generated by the controller 104 of the PCF orchestrator 140 using one or more algorithms 233, one or more protocols 232, and/or stored data 234. In some cases, there can be a table for a particular schema. For example, there can be a table for an emissions schema, where the contents of the table can include a start date, an end date, a source, an organizational attribution, a geographic location, a facility name, an amount of emissions, a type of emissions, and a unit of the emissions. As another example, a table for a stage schema can include a stage, an index, a geographic location, a facility, and a name. As yet another example, a table for a production allocation schema can include a start date, an end date, a ratio, a stage index, and a product. Each table can be part of the PCF determination package 185 that is sent to the customer as set forth in step 482 of FIG. 4 above. When step 584 is complete, the process proceeds to the END step.

FIG. 6 shows a flowchart 658 of a method for providing a data contract and accompanying instructions to a customer 150 according to certain example embodiments. While the various steps in this flowchart 658 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 6 may be included in performing this method. Accordingly, the specific arrangement of steps should not be construed as limiting the scope. Further, a particular computing device, such as the computing device 318 discussed above with respect to FIG. 3, may be used to perform or facilitate performance of one or more of the steps (or portions thereof) for the method shown in FIG. 6 in certain example embodiments. Any of the functions (or portions thereof) performed below by a controller 104 may involve the use of one or more protocols 232, one or more algorithms 233, and/or stored data 234 stored in a storage repository 231. In some cases, one or more of the various steps in the method of FIG. 6 can be performed automatically, as by a controller 104 of a PCF orchestrator 140.

The method shown in FIG. 6 is merely an example that may be performed by using an example system described herein. In other words, systems for providing a data contract and accompanying instructions to a customer 150 may perform other functions using other methods in addition to and/or aside from those shown in FIG. 6. Referring to FIGS. 1 through 6, the method shown in the flowchart 658 of FIG. 6 begins at the START step and proceeds to step 681, where query information about a customer 150 is requested. The query information that is requested can be determined by the controller 104 of the PCF orchestrator 140 (e.g., using one or more protocols 232), by the network manager 180, by one or more customers 150, by one or more suppliers 151, and/or by some other entity. In certain example embodiments, the query information is directed to determining a platform (e.g., the manufacturer of the platform, the model and version of the platform, any special features of the platform) used by the customer 150. Information about the platform allows enterprise taxonomy data to be configured and mapped as part of the data contract within the PCF platform.

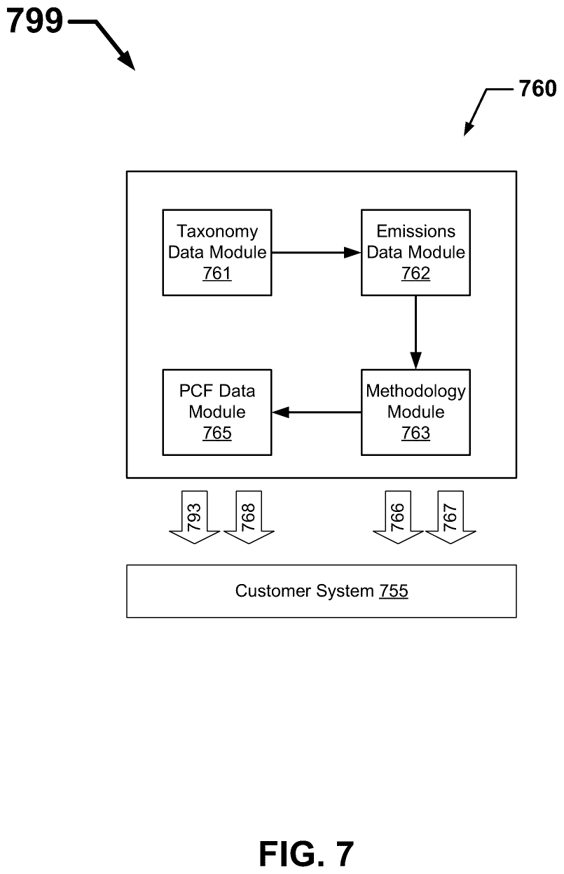

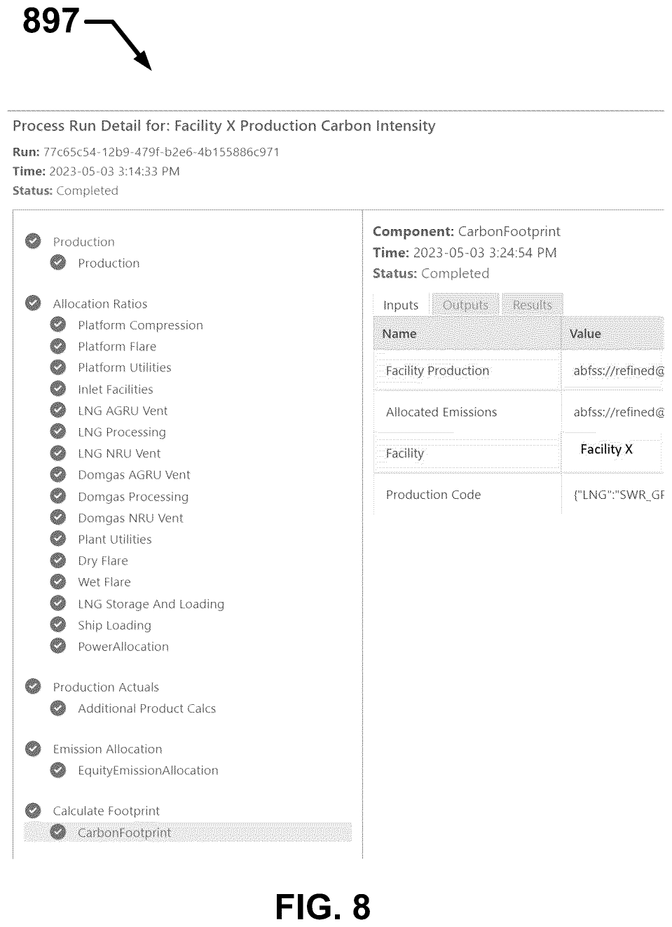

The request for the query information can be made through the PCF platform (discussed below with respect to FIG. 7). The request for the query information can be made by the controller 104 of the PCF orchestrator 140, the controller 104 can perform the identification using the application interface 226, the communication module 207, one or more algorithms 233, one or more protocols 232, and/or stored data 234. In addition, or in the alternative, the request for the query information can be made by the PCF platform, which can include a controller that has components and/or functionality that are similar to those of the controller 104 of the PCT orchestrator 140. In some cases, the query information can be requested in stages, where query information requested in a subsequent stage can be based on a response to a prior request for query information from the customer 150.

In step 682, the query information is obtained from the customer 150. The query information can be delivered by a customer system 155 of the customer 150. The query information can be obtained by the controller 104 of the PCF orchestrator 140. In addition, or in the alternative, the query information can be obtained by the PCF platform, which can include a controller that has components and/or functionality that are similar to those of the controller 104 of the PCT orchestrator 140.

In step 683, the query information is applied to the PCF determination package 185. The query information can be applied to the PCF determination package 185 by the controller 104 of the PCF orchestrator 140 using one or more protocols 232, one or more algorithms 233, and/or stored data 234. In addition, or in the alternative, the query information can be obtained by the PCF platform, which can include a controller that has components and/or functionality that are similar to those of the controller 104 of the PCT orchestrator 140. In some cases, the controller 104 of the PCF orchestrator 140 can be the same as the controller for the PCF platform. As discussed above, after applying the query information to the PCF determination package 185, one or more subsequent requests for additional query information can be made.

In step 684, a data contract and instructions are generated using the query information. The data contract and instructions can be generated by the controller 104 of the PCF orchestrator 140 using one or more protocols 232, one or more algorithms 233, and/or stored data 234. In addition, or in the alternative, the data contract and instructions can be generated by the PCF platform, which can include a controller that has components and/or functionality that are similar to those of the controller 104 of the PCT orchestrator 140. In some cases, the controller 104 of the PCF orchestrator 140 can be the same as the controller for the PCF platform.

As an example, the allocations of various products based on rules within the methodology (e.g., data mapping and configuration) are converted to actual arithmetic statements, which are then translated into primitives (e.g., foundational data structures or code elements) on the customer system 155 of the customer 150 using the PCF platform. In other words, the code embodied in the methodology definition of the PCF orchestrator 140 may be translated to the data structures or code on the target customer system 155 using data and language elements native to that customer system 155. In this way, the PCF orchestrator 140 may not require special software to reside and function on the customer system 155. Rather, the PCF orchestrator 140 uses features native to the customer system 155 to execute the methodology with the permission of the customer system 155.

In certain example embodiments, the data contract and instructions that are customized for the customer system 155 is based, in part, on the type of emission data that resides within the customer system 155. In some cases, this may lead to creating additional instructions (e.g., related to an audit trail). In some cases, this allows all of the data to remain within the customer system 155 by manipulating the customer system 155 on behalf of the customer 150 to prepare the emissions data and allocations to generate a report including the PCF value. Put another way, the data contract and the instructions may be configured to instruct the customer system 155 as to how to format the emission-related data. For example, the data contract may dictate how the data is formatted (e.g., aggregate data residing in certain particular fields of a table, average the data residing in certain other particular fields of a table) to be compatible with the methodology.

In some cases, a customer 150 (or an associated customer system 155) may elect a methodology to implement from among multiple methodologies. When the selection is made, the PCF orchestrator 140 may initiate generating the data contract and associated instructions based on the selection. In alternative embodiments, the PCF orchestrator 140 may survey the emissions data and/or data sources on the customer system 155. Once the survey is complete, the PCF orchestrator 140 may determine the methodology among multiple methodologies that is best suited for the customer 150 based on what is surveyed in the customer system 155.

In step 686, the data contract and instructions are provided to the customer system 155. The data contract and instructions can be provided to the customer system 155 of a customer 150 by the controller 104 of the PCF orchestrator 140 using one or more protocols 232, one or more algorithms 233, and/or stored data 234. In addition, or in the alternative, the data contract and instructions can be provided to the customer system 155 of a customer 150 by the PCF platform, which can include a controller that has components and/or functionality that are similar to those of the controller 104 of the PCF orchestrator 140. In some cases, the controller 104 of the PCF orchestrator 140 can be the same as the controller for the PCF platform. According to example embodiments, the data contract and instructions are delivered remotely to the customer system 155 by the PCF orchestrator 140. Further, subsequently, the data contract and instructions, which are customized for the customer system 155 based on the query information, are executed remotely on the customer system 155 without interaction with the PCF orchestrator 140.

The data contract and accompanying instructions can be specific for the customer system 155 of a customer 150 based on the query information. The data contract and accompanying instructions can be provided via access (e.g., secure access) to an online portal. Alternatively, the data contract and accompanying instructions can be downloaded (e.g., from a web site, from a CD) to a customer system 155 of the customer 150. In other cases, the data contract and accompanying instructions can be provided to the customer system 155 of a customer 150 in some other way. In any case, the customer system 155 of a customer 150 retains control of its emissions data when accessing and using the data contract.

A data contract can include one or more tables (or portions thereof) of the PCF determination package 185. In such a case, the customer system 155 of a customer 150 provides the information that fills each table for the data contract. For example, if a customer system 155 of a customer 150 has a table for an emission schema as part of its PCF determination package, then the customer system 155 of a customer 150 can provide a start date of Jan. 1, 2023, an end date of Mar. 31, 2023, a source of system of record A, an organizational attribution of Safety, a geographic location of Australia, a facility name of Facility ABC, an amount of emissions of 123456, a type of emissions of methane, and a unit of the emissions of CO₂c.

As another example, if a customer system 155 of a customer 150 has a table for a stage schema as part of its PCF determination package, then the customer system 155 of a customer 150 can provide a stage of Upstream, an index of 1, a geographic location of Australia, a facility of Facility ABC, and a name of power. As yet another example, if a customer has a table for a production allocation schema as part of its PCF determination package, then the customer system 155 of a customer 150 can provide a start date of Jan. 1, 2023, an end date of Mar. 31, 2023, a ratio of 0.851414, a stage index of power, and a product of LNG. When step 686 is complete, the process proceeds to the END step.

FIG. 7 shows an example of a subsystem 799 that includes a PCF platform 760 of a PCF determination package 185 according to certain example embodiments. Referring to FIGS. 1 through 7, the PCF platform 760 can be configured to generate a data contract 766 and associated instructions 767 for a customer system 155 of a customer 150 by applying query information received from the customer system 155 of a customer 150 to the PCF determination package 185. The PCF platform 760 can have one or more modules and/or components. For example, as shown in FIG. 7 for this example, the PCF platform 760 can include a taxonomy data module 761, an emissions data module 762, a methodology module 763, and a PCF data module 765. In alternative embodiments, one or more of these modules of the PCF platform 760 can be combined with each other. In yet other alternative embodiments, one or more of these modules of the PCF platform 760 can be divided into multiple modules.

These modules of the PCF platform 760 can operate simultaneously with respect to each other or discretely as steps in an ordered process. For example, in this case, the modules of the PCF platform 760 are configured to operate in an ordered process, where the output of the taxonomy data module 761 is used as input for the emissions data module 762, the output of which is used as input for the methodology module 763, the output of which is used as input for the PCF data module 765, which yields the output 793 (which includes the one or more PCF values) and, in some cases, an audit report 768.

As discussed above, the output 793 of the PCF platform 760 received by a customer system 755 of a customer 150 may be the same as, or different than, the PCF results 195 delivered by a customer system 755 of a customer 150 to the PCF orchestrator 140. For example, the output 793 of the PCF platform 760 received by a customer system 755 of a customer 150 may include one or more PCF values supported by multiple reports, an audit report 768, and a summary. By contrast, the PCF results 195 delivered by a customer system 755 of a customer 150 to the PCF orchestrator 140 may only include the one or more PCF values. The output 793 of the PCF platform 760 received by a customer system 755 of a customer 150 may be used for one or more of any number of purposes (e.g., compliance, reporting to shareholders and/or other stakeholders, budgeting, capital improvement planning, marketing, trading, industry benchmarking, internal benchmarking). In certain example embodiments, a customer system 755 of a customer 150 may interface with the PCF platform 760 to customize the output provided by the PCF platform 760 so that the output 793 of the PCF platform 760 meets the needs for the one or more purposes for which the customer system 755 of a customer 150 intends to use the output 793.

Using the PCF platform 760 to generate the data contract 766 and accompanying instructions 767, derived from the PCF determination package 185, a customer system 755 of a customer 150 can prepare and map the relevant data (e.g., primary data, secondary data) for calculation to data contract format (e.g., using the methodology module 763). The PCF platform 760 can express the value chain as a workflow in order to standardize the method in which the PCF value is determined (e.g., calculated) given a standard data contract.

The PCF platform 760 can be a web-based tool that each customer system 755 of a customer 150 (including associated suppliers 151 and/or representatives of a customer 150) can access to determine the PCF value of the customer 150. In such a case, the customer system 755 of a customer 150 accesses the PCF platform 760 through a portal (e.g., a secure portal) without having to download software and without having to release or lose control of any emissions data. Alternatively, the PCF platform 760 can be software that is resident on a customer system 755 (e.g., downloaded from a website, downloaded from a CD) of the customer 150. In this case, the customer 150 also retains control of its emission data.

The instructions 767 that accompany the data contract 766 generated by the PCF platform 760 and that are derived from the PCF determination package 185 can include tracking information and input dataset effective dates in order to isolate and reproduce the calculation results. The customer system 755 (similar to a customer system 155) can include a data contract library that accepts the data contract 766 and accompanying instructions 767 (e.g., calculation instructions), performs the calculations, and stores the output 793 and/or the audit report 768 in a standardized location in the customer system 755.

An example of a coded instruction can be: /product-id/{tracking id}/standardized-product-dataset. The instructions 767 can be expressed in a standard query language format that is specifically targeted for the computing environment of the customer system 755. The instructions 767 can provide for assigning and/or receiving tracking identification references and/or effective dates of the data. The instructions 767 can also provide for calculation proofs, including copies of source information required to calculate or otherwise determine the PCF value, and a standardized resultant footprint dataset that is shared with data contract 766 via the application interface (similar to the application interface 226 of the controller 104) of the customer system 755.

The PCF platform 760 can validate and orchestrate PCF values across a network of supplier systems 152 of one or more suppliers 151 for a customer 150. For example, the PCF platform 760 can serve as the orchestration service in which the PCF values are calculated or otherwise determined across a value chain by coordinating when individual segments are needed. As another example, the PCF platform 760 can store and supply standardized PCF data from one or more supplier systems 152 via an application interface of the customer system 155. As yet another example, the PCF platform 760 can provide product footprint data and/or secondary data to a customer system 755 of a customer 150 where appropriate and as a part of the process in determining the PCF value for the customer 150.

The PCF platform 760 can map data from the system of record emissions schema formats to target standardized schema for the data contract 766. For example, the PCF platform 760 can orchestrate data preparation activities to extract-load and translate data from a system of record (e.g., from the customer system 755 of a customer 150, from a supplier system 152 of a supplier 151) to target data contract format by delivering specific instructions to the customer system 755 of the customer 150. In such cases, the data translation process can preserve data in standard physical storage locations in the customer system 155 to preserve lineage and auditability of the process. As another example, the PCF platform 760 can contain mappings to translate information between participating system of record schemas and target data contract language.

In certain example embodiments, the PCF platform 760 can allow for a hybrid situation where one or more of the supplier systems 152 of the suppliers 151 and/or the customer system 755 of the customer 150 has limited data and/or limited computing capabilities. For example, some of the data provided by one or more supplier systems 152 of the suppliers 151 for a customer 150 is not facilitated through a corresponding supplier system 152. In such cases, the PCF platform 760 can allow participants (e.g., the customer system 755 of the customer 150, the supplier systems 152 of one or more suppliers 151) to upload data that adheres to the standard data contract in situations where those participants do not have a supported computing environment. Also in such cases, the PCF platform 760 can deliver calculation instructions 767 in the same manner as other participants and preserves data lineage and calculation proofs within the PCF platform 760.

Each of the modules and/or components (including portions thereof) of the PCF platform 760 can be generated and maintained (e.g., revised, deleted, added) by the data contract generation module 274 of the controller 104 of the PCF orchestrator 140. Each of the modules and/or components (including portions thereof) of the PCF platform 760 can be configured for each specific customer system 755 of a customer 150, for customer systems 755 of multiple customers 150 categorized in a group, for customer systems 755 of all customers 150 generically, and/or in some other fashion. The PCF platform 760 is received by a customer system 755 from the PCF orchestrator 140 and resides on the customer system 755. In this way, none of the data of the customer system 755 of a customer 150 used to determine the PCF value of the customer 150 leaves the control of the customer 150 for a third party, including the PCF orchestrator 140.

The taxonomy data module 761 of the PCF platform 760 can be used, in part, to implement a hierarchical structure that separates the various emission data of the customer 150, resident on the customer system 755, into specific classes of data. The taxonomy data module 761 can be implemented autonomously and/or by the customer system 755 of a customer 150 using the instructions 767 that accompany the data contract 766 generated by the PCF platform 760 as derived from the PCF determination package 185. The taxonomy data module 761 can communicate directly with one or more customer systems 755 of the customer 150 and/or one or more supplier systems 152 of one or more of the suppliers 151 of the customer 150.

The emissions data module 762 of the PCF platform 760 can be used, in part, to request and receive the emissions data needed by the PCF platform 760 to determine the PCF value(s) (part of the output 793) of the customer 150. The emissions data module 762 can be implemented autonomously and/or by the customer system 755 of a customer 150 using instructions 767 that accompany the data contract 766 output by the PCF platform 760 as derived from the PCF determination package 185. The emissions data module 762 can communicate directly with one or more customer systems 755 of the customer 150 and/or one or more supplier systems 152 of one or more of the suppliers 151 of the customer 150. The emission data module 762 can be executed using, in part, the output of the taxonomy data module 761.

The methodology module 763 of the PCF platform 760 can be used, in part, to prepare the emissions data to determine the PCF value of the customer 150. For example, the methodology module 763 can be configured to link a methodology implementation to a known, flat data contract 766 that allows one or more teams (e.g., customer systems 755) internal to the customer 150, an independent software vendor (e.g., part of a customer system 755) of the customer 150, or consulting firms (e.g., using a customer system 755, as part of a supplier system 152) of the customer 150 to provide implementations that are specific to the customer 150.

The methodology that is part of the methodology module 763 can include a series of steps and/or workflows (e.g., protocols 232) and formulas (e.g., algorithms 233) that have been codified as the instructions 767. In this way, the data contract 766 and some or all of the accompanying instructions 767 can be derived from the PCF determination package 185 by the methodology module 763. For example, the instructions 767 generated by the methodology module 763 can include, in order of performance, performing product allocations, allocating emissions, determining and employing weighting factors, and calculating the PCF value.

The methodology module 763 can also detail any of the broader steps with sub steps and/or instructions 767. For example, a general step of performing product allocations can be further defined as calculating the product allocation of product 1, followed by calculating the product allocation of product 2, followed by adding the product allocations of product 1 and product 2 to determine the allocation of the total production. The methodology module 763 can be implemented autonomously and/or by the customer system 755 of a customer 150 using the instructions 767 that accompany the data contract 766 output by the PCF platform 760 and as derived from the PCF determination package 185. The methodology module 763 can communicate directly with one or more customer systems 755 of the customer 150 and/or one or more supplier systems 152 of one or more of the suppliers 151 of the customer 150.

The methodology module 763 can be executed using, in part, the output of the taxonomy data module 761 and/or the emission data module 762. In some cases, the methodology module 763 can incorporate and/or output the data contract 766 and accompanying instructions 767 that are delivered to a customer system 755. In such cases, the instructions of the methodology module 763 can include data mapping (e.g., linking each source to a targeted portion of the data contract 766) for the source emission schemas for the customer 150. The instructions 767 of the methodology module 763 can include data transformation instructions that are delivered to the customer system 755. The methodology module 763 can be configured to land data in a location that is accessible for internal computation of a customer system 755 in executing the data contract 766 per the instructions 767. An example of such a format is: /data-contract-name-version/YYYY-MM-DD/data-contract-dataset.

In some cases, the methodology module 763 can break the data contract 766 into schemas, where each schema is well defined and includes one or more inputs and one or more outputs. In this way, the methodology employed by the methodology module 763 in the data contract 766 can apply a “scoping predicate” to filter incoming input data and apply filters to one or more of the subsequent steps, which can also apply other “scoping predicates” to filter the subsequent incoming input data. For example, for a particular facility of a customer 150 at a particular geographic location, the data contract 766 can have an emissions schema, a production schema, and an allocation schema. In such a case, once the input data has been received, the process can be broken down into an LNG allocation, a condensate allocation, and a domestic gas (domgas) allocation. The results of these subsequent allocations can result in the PCF results 795 output by the PCF data module 765.

In certain example embodiments, the methodology module 763 may be configured to generate and/or modify one or more weighting factors that are used to help determine a PCF value. For example, the methodology module 763 may generate the weighting factors that can be applied to standardized segment emissions and standardized product data generated by, for example, the emissions data module 762. One or more of the weighting factors may be pre-determined values that are based on one or more of a number of factors, including but not limited to the value chain segment and associated products, the range of time, the supplier(s) 151, the customer 150, and the industry. Alternatively, one or more of the weighting factors may be generated and/or altered in real time by the methodology module 763, the network manager 180, the customer system 755 of the customer 150, and/or some other entity (e.g., a government agency, a voluntary emission program administrator).

A weighting factor may be used to allocate emissions to one or more different products associated with the customer 150 and/or one or more of the suppliers 151 of a value chain. Standardized segment emissions may be allocated to one or more products and/or services. For example, an allocation may include applying weighting factors to corresponding product data to generate weighted values. The weighted values may then be added to obtain the total weighted value (TWV, as a percentage, this should be 100%). The weighted value and proportion of the TWV may then be used to determine (e.g., calculate) standardized allocated emissions for each product and a standardized PCF value for each product in the value chain. The following table shows an example of this functionality of the methodology module 763:

| | | | | | | CFP Value |
|---|---|---|---|---|---|---|
| | Supplier | | | | Allocated | (in tCO2e |
| Co- | Production | Weighting | Weighted | Proportion | Emissions | per unit of |
| Product | Data | Factor | Value | of TWV | (in tCO2e) | production) |
| Product 1 | X | A | X × A | XA/TWV | (XA/TWV) × | [(XA/TWV) × |
| | | | | | TE | TE] / X |
| Product 2 | Y | B | Y × B | YB/TWV | (YB/TWV) × | [(YB/TWV) × |
| | | | | | TE | TE] / Y |
| Product 3 | Z | C | Z × C | ZC/TWV | (ZC/TWV) × | [(ZC/TWV) × |
| | | | | | TE | TE] / Z |
| Total | TE(CO2e) | | TWV = XA + | | | |
| Emissions | | | YB + ZC | | | |

In certain example embodiments, the methodology enabled by the methodology module 763 are additive and can append, without changing, the information from input data sets of a customer system 755 of a customer 150. In other words, the PCF platform 760 can produce a data contract 766 that has new fields for calculations, lookups, and/or any other function to preserve the integrity of the original data. Also, output datasets are designed to be “wide” and reflect all inputs/outputs for a particular run, including any calculations (e.g., C=A+B−D).

Further, all inputs and outputs of the PCF platform 760 can be recorded “as is” relative to the specific run for determining the output 793 (including the PCF values 195) of the PCF platform 760. In other words, the data is immutable and stored. Each step in the methodology implementation of the data contract 766 is designed to store all inputs and outputs relative to the individual run identification in a location that is designed to be immutable. As a result, the methodology is stateless and can be reproduced at any point in time for any customer system 755 of a customer 150. The methodology is tied to input schema and so can be scoped (filtered) to a predicate. For example, a scoped predicate indicating “Facility ABC” can exclude any data outside the facility for any subsequent steps and does not need to be individually configured. The methodologies can be relatively generic, and so they can be shared across facilities or organizations in the PCF determination package 185 and then integrated into an individual data contract 766.

The PCF data module 765 of the PCF platform 760 can be used, in part, to generate the output 793 (which can include the PCF results 195 discussed above) and/or an audit report 768 (e.g., for the calculations performed to determine the PCF value) for the customer 150. The instructions 767 that accompany the data contract 766 generated by the PCF data module 765 can be translated to the target data and compute environments performed on the customer system 755 of the customer 150. In this way, the PCF data module 765 can reduce the IT burden and complexity on the customer system 755 of a customer 150 since data does not leave the customer system 755 of the customer 150 and requires no specific data contract deployment.

The PCF data module 765 can be implemented autonomously and/or by the customer system 755 of a customer 150 using the instructions 767 that accompany the data contract 766 output by the PCF platform 760 as part of the PCF determination package 185. The PCF data module 765 can communicate directly with one or more customer systems 755 of the customer 150 and/or one or more supplier systems 152 of one or more of the suppliers 151 of the customer 150. The PCF data module 765 can be executed using, in part, the output of the taxonomy data module 761, the emission data module 762, and/or the methodology module 763. In some cases, the PCF data module 765 can incorporate and/or output the data contract 766 and accompanying instructions 767 that are delivered to a customer system 755. In such cases, the instructions 767 of the PCF data module 765 can include instructions on how sequenced calculations using prepared emissions data are to be performed for the data contract 766. The inputs, outputs, and assumptions are easily auditable (e.g., as captured in an audit report 768) because they are recorded and cannot be tampered with by the customer 150 or associated customer system 755 or any other entity. The output 793 of the PCF platform 760 can be reproduced by re-running the same run ID (part of the data contract 766) at any point in time.

FIGS. 8 through 12 show screenshots of various screens displayed on a user interface while orchestrating the determination of a PCF according to certain example embodiments. Referring to FIGS. 1 through 12, the screenshot 897 of FIG. 8 shows a screenshot 897 of the Input tab for showing a calculated carbon footprint for Facility X production carbon intensity. The inputs for the carbon footprint in this example are facility production, allocated emissions, facility, and production code. In this case, the PCF is calculated, so the screenshot 897 of FIG. 8 could be viewed by a customer finishing the processes of calculating the PCF for Facility X and/or an auditor undergoing the process of reviewing the inputs for the calculation of the PCF for approval. The screenshot 897 shows that all of the items (in this case, the production, all of the allocation ratios, the production actuals, the emission allocation, and the calculate footprint) listed along the left part of the screen are completed at the time the screenshot 897 is captured. In alternative embodiments, additional and/or alternative inputs may be part of the process shown in the screenshot 897. In alternative embodiments, the number of inputs may differ from what is shown in the screenshot 897 of FIG. 8. In some cases, the inputs shown in the screenshot 897 of FIG. 8 may differ depending on the user viewing it.

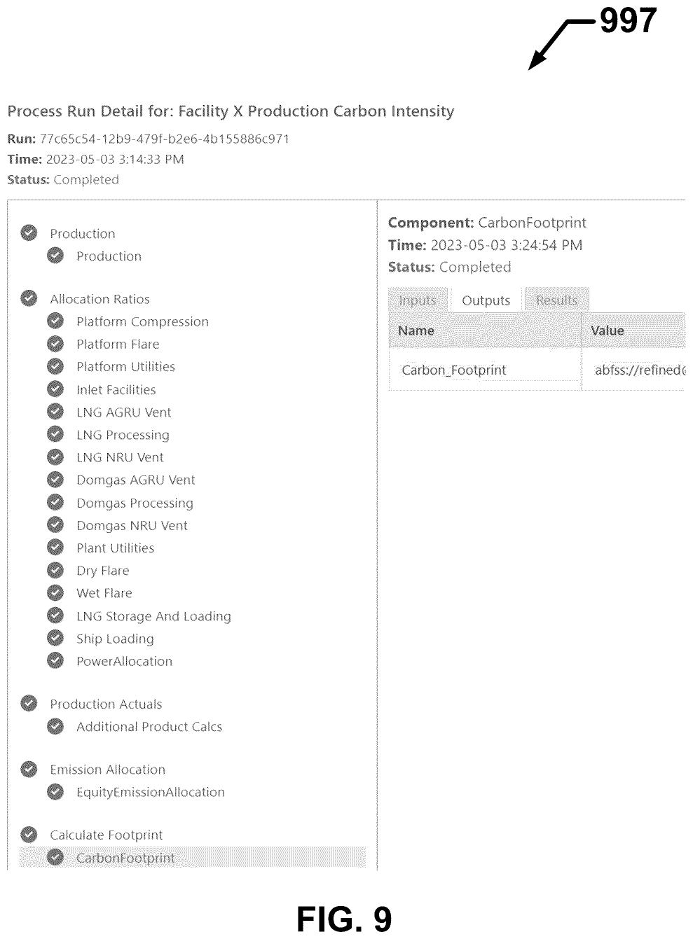

The screenshot 997 of FIG. 9 captures the Output tab for showing a calculated carbon footprint for Facility X production carbon intensity. The lone output for the carbon footprint in this example is the carbon footprint. The output tab of the screenshot 997 of FIG. 9 is adjacent and complementary to the Input tab of the screenshot 897 of FIG. 8. As a result, the screenshot 997 shows that all of the items (in this case, the production, all of the allocation ratios, the production actuals, the emission allocation, and the calculate footprint) listed along the left part of the screen are completed at the time the screenshot 997 is captured. In this case, the PCF is calculated, so the screenshot 997 of FIG. 9 may be viewed by a customer finishing the processes of calculating the PCF for Facility X and/or an auditor undergoing the process of reviewing the inputs for the calculation of the PCF for approval. In alternative embodiments, additional and/or alternative outputs may be part of the process shown in the screenshot 997. In alternative embodiments, the number of outputs may differ from what is shown in the screenshot 997 of FIG. 9. In some cases, the outputs shown in the screenshot 997 of FIG. 9 may differ depending on the user viewing it.

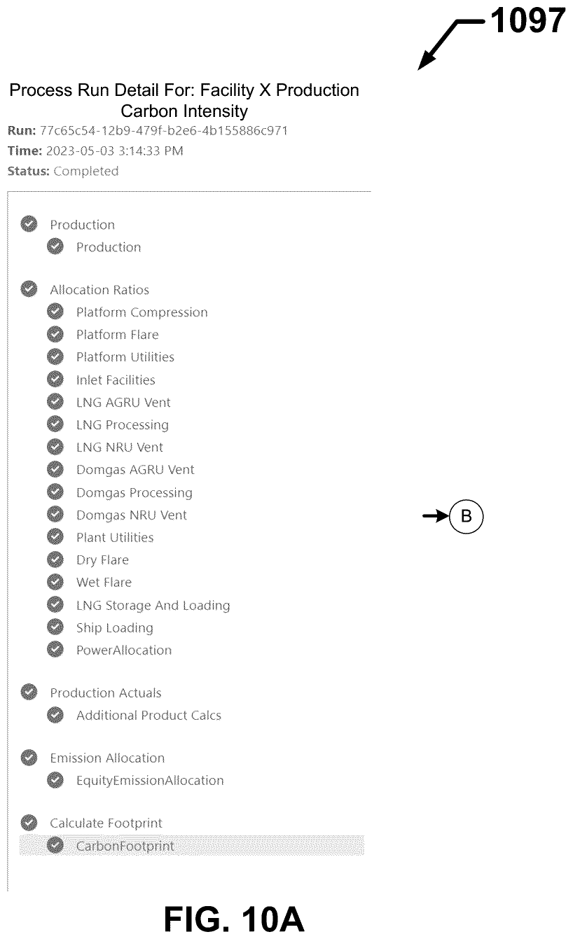

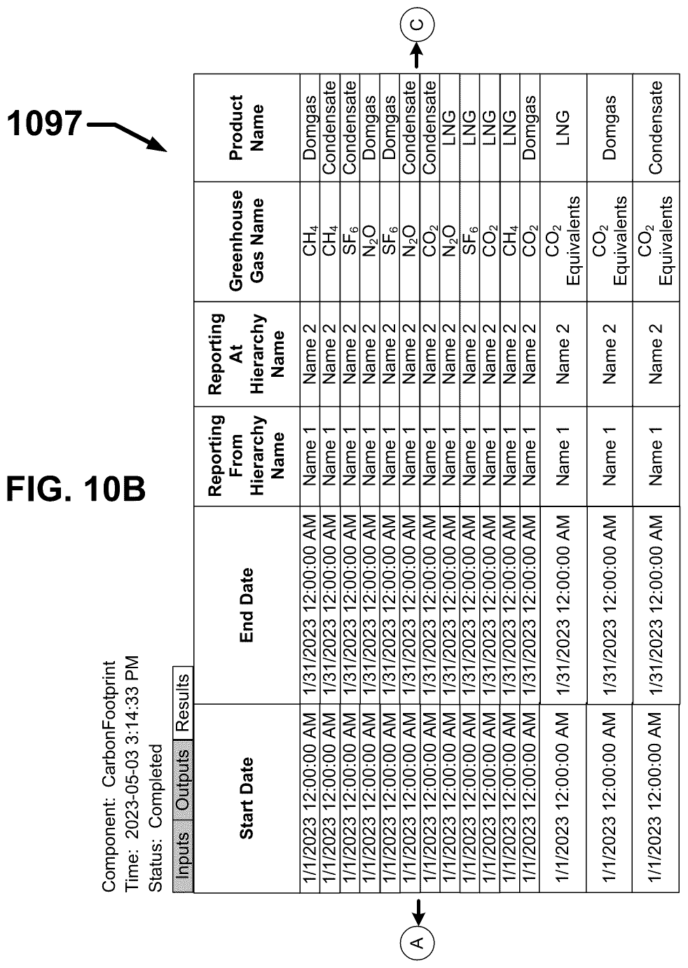

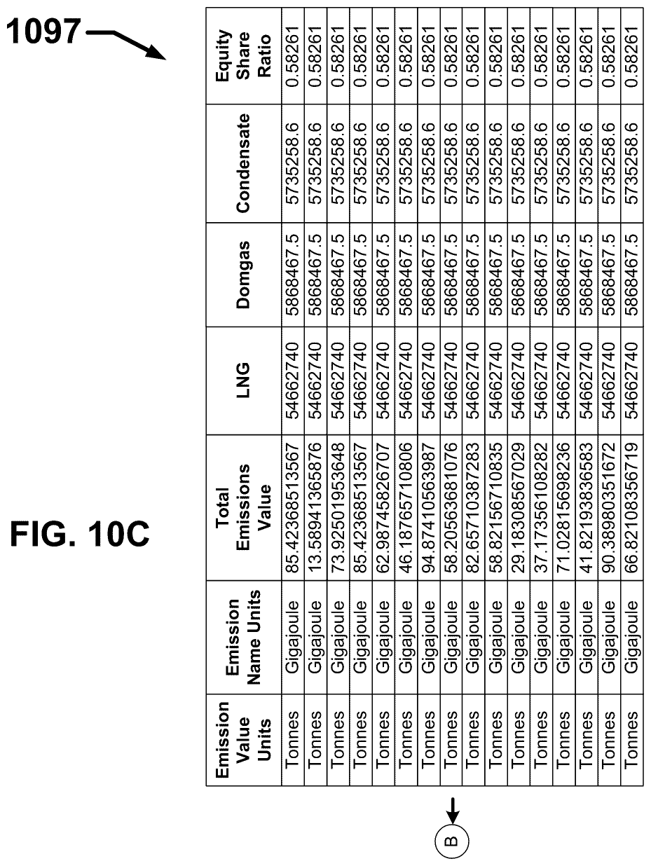

FIGS. 10A through 10C show different parts of a screenshot 1097 that captures the Results tab, which is adjacent and complementary to the Input tab (as shown in FIG. 8) and the Output tab (as shown in FIG. 9). In certain example embodiments, there may be fewer than three tabs, more than three tabs, and/or alternative tabs relative to Input, Output, and/or Results. The screenshot 1097 shows that all of the items (in this case, the production, all of the allocation ratios, the production actuals, the emission allocation, and the calculate footprint) listed along the left part of the screen (shown in FIG. 10A) are completed at the time the screenshot 997 is captured.

The portions of the screenshot 1097 captured in FIGS. 10B and 10C show details of the results broken down by start date, end date, hierarchy names (e.g., reporting from, reporting at), greenhouse gas, product, emission units, emission values, emission values contributed from LNG, emission values contributed from domgas, emission values contributed from condensate, and equity share ratio. In alternative embodiments, additional and/or alternative factors may be part of the table shown in the Results tab. In alternative embodiments, a lower number of factors or a larger number of factors may be included in the table shown in the Results tab. In this case, the PCF is calculated, so the screenshot 1097 of FIGS. 10A through 10C could be viewed by a customer finishing the processes of calculating the PCF for Facility X and/or an auditor undergoing the process of reviewing the inputs for the calculation of the PCF for approval.

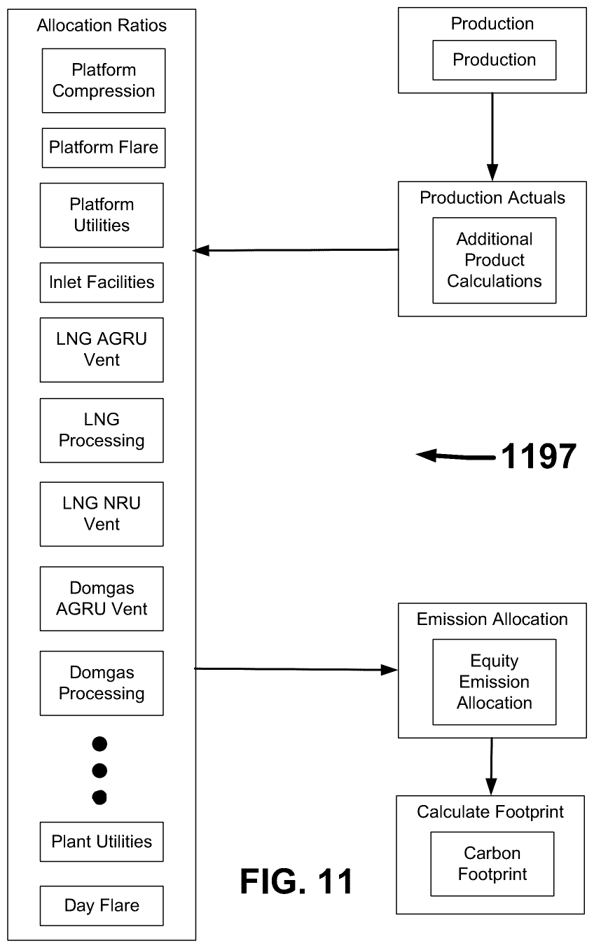

FIG. 11 shows a screenshot 1197 of a process (e.g., a workflow) that a user (e.g., a customer, an auditor) may follow, in whole or in part, to achieve the results of the PCF determination. In this case, the process shown in the screenshot 1197 includes a production module (with production data), a production actuals module (with additional product calculations), an allocation ratios module (with units including platform compression, platform flare, platform utilities, inlet facilities, LNG AGRU vent, LNG processing, LNG NRU vent, domgas AGRU vent, domgas processing, plant utilities, and day flare, among others), an emission allocation module (with equity emission allocation), and a calculate footprint module (with a carbon footprint). In alternative embodiments, additional and/or alternative modules (including portions thereof) may be part of the process shown in the screenshot 1197. In alternative embodiments, portions of a module in the process may differ from what is shown in the screenshot 1197 of FIG. 11. In some cases, the process shown in the screenshot 1197 of FIG. 11 may differ depending on the user viewing it.

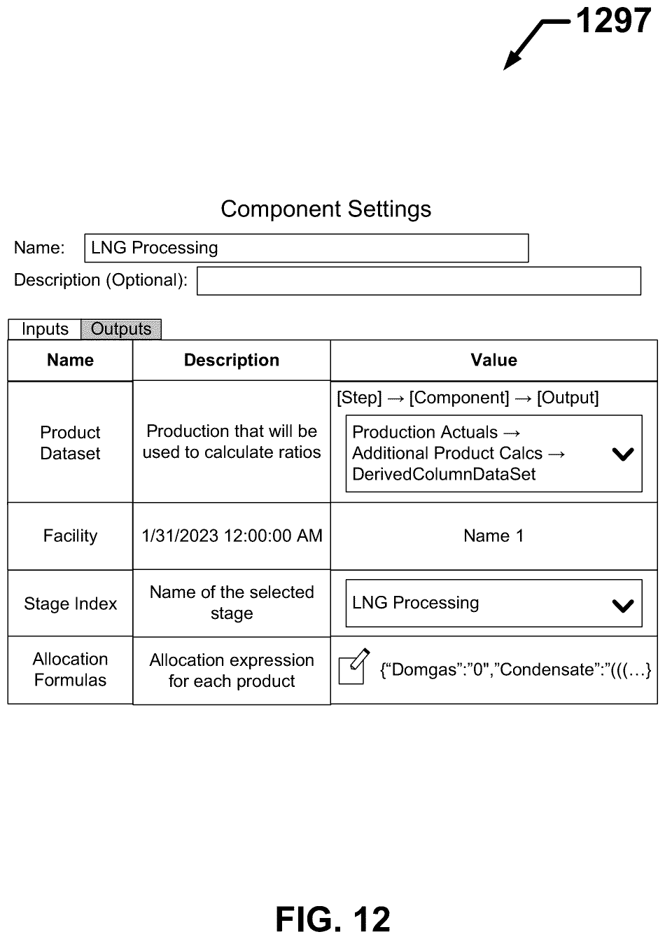

FIG. 12 shows a screenshot 1297 of component settings. In this case, the settings shown in the screenshot 1297 are for LNG processing with an Input tab (active in this case) and an Output tab (inactive in this case). Each input shown as part of the Input tab in this example includes a name, a description, and a value. Specifically, there are four line items in the screenshot 1297. The first line item has a name (product dataset), a description (production that will be used to calculate ratios), and a value (a selectable field that in this case is product actuals (a step) followed by additional product calcs (a component) followed by “derivedcolumndataset” (an output).

The second line item has a name (facility), a description (Jan. 31, 2023 12:00:00 AM), and a value (Name 1). The third line item has a name (stage index), a description (name of the selected stage), and a value (a selectable field that in this case is LNG processing). The fourth line item has a name (allocation formulas), a description (allocation expression for each product), and a value (a selectable field that in this case has a string of code that includes domgas and condensate). In alternative embodiments, each line item of the screenshot 1297 may have additional and/or alternative fields. The fields of a line item may be made by default, selectable by a user, and/or tailored to a particular user (e.g., a customer, an auditor).

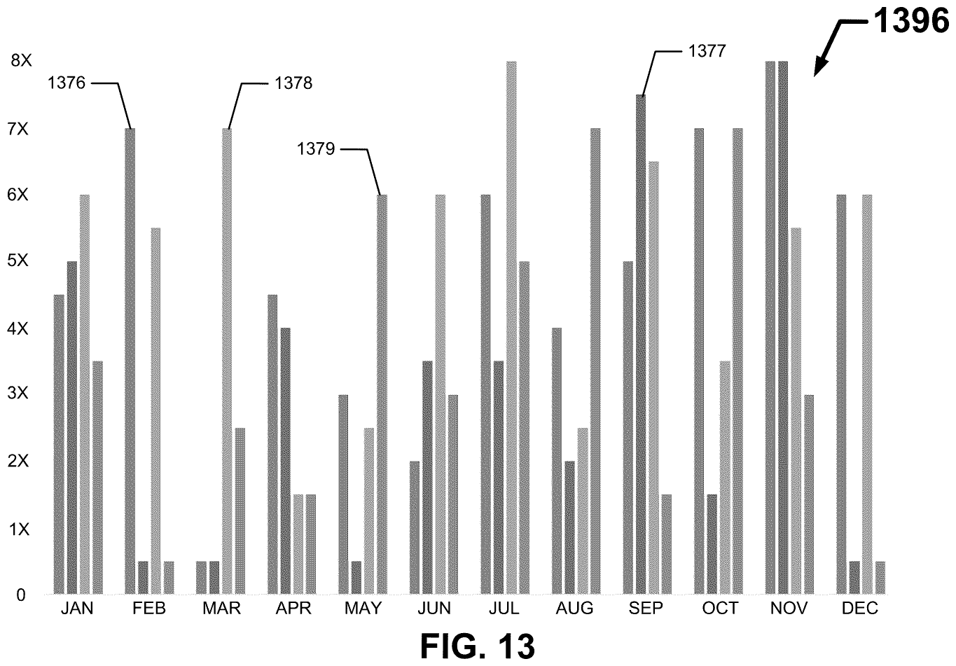

FIG. 13 shows a graph 1396 with monthly PCF values by product for a corporate entity according to certain example embodiments. Referring to the description above with respect to FIGS. 1 through 12, the graph 1396 shows the PCF value (in gCO2e/MJ) along the vertical axis versus time along the horizontal axis. The vertical axis has a linear scale in terms of the variable X. The time is shown in twelve one-month increments along a linear scale. For each month, the PCF value for each of four products is shown. Product 1376 is shown first at each monthly increment, followed by product 1377, followed by product 1378, followed by product 1379. The bar for any product within any month can be selectable by a user (e.g., a customer 150, an auditor) to reveal details (e.g., raw data, approvers, sources of data, formulas used) behind the PCF value for that product in that month.

The graph 1396 of FIG. 13 can be generated and presented by the control engine 206 of the controller 104 of the PCF orchestrator 140, for example, automatically, based on instructions from a user (e.g., a customer 150), or based on some other factor or condition. In alternative embodiments, other variables (e.g., fuel type, subsidiary, geographic area) may be used in place of product in the graph 1396. In addition, or in the alternative, other units of time (e.g., by week, by quarter, by year) may be shown in the graph 1396.

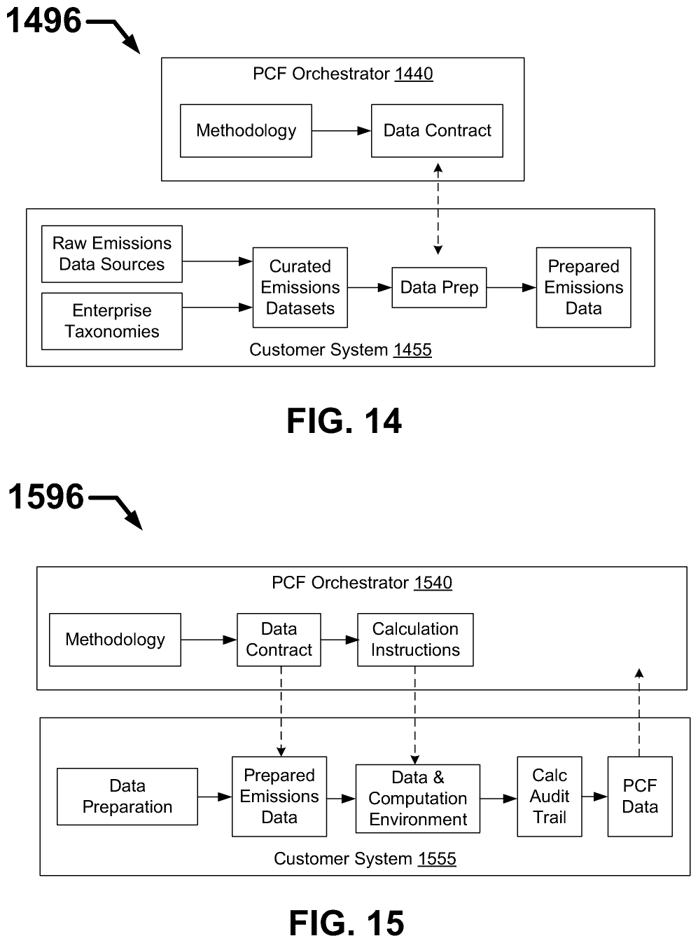

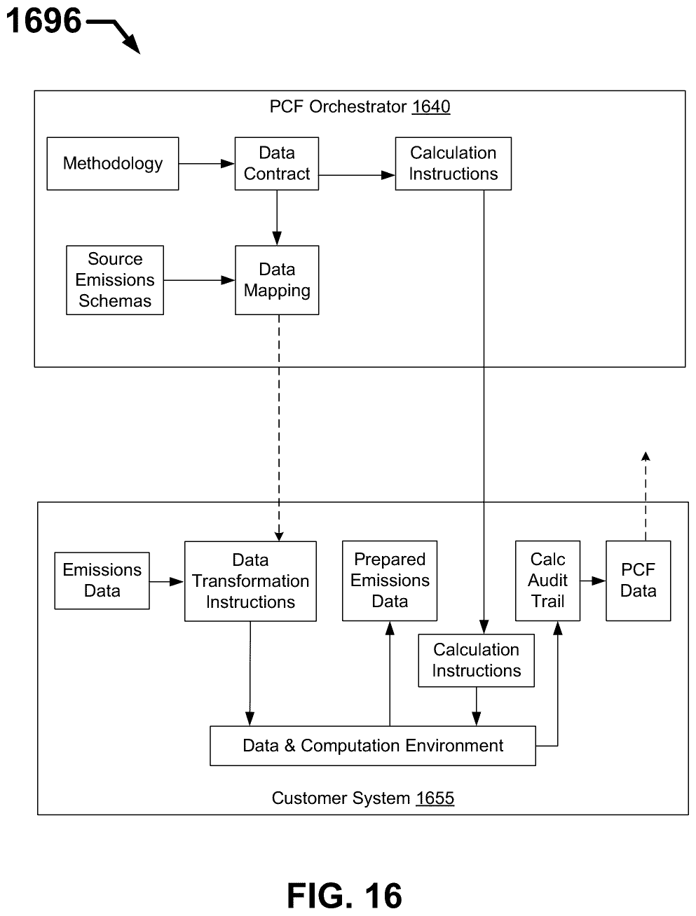

FIGS. 14 through 16 show various flowcharts for implementing methodologies according to certain example embodiments. Specifically, FIG. 14 shows a flowchart 1496 for implementing a methodology. FIG. 15 shows a flowchart 1596 for implementing another methodology. FIG. 16 shows a flowchart 1696 for implementing yet another methodology. Referring to the description above with respect to FIGS. 1 through 13, the flowchart 1496 of FIG. 14 shows an example where the methodology is implemented as a relatively simple data contract (e.g., data contract 766) by a PCF orchestrator 1440 for a customer system 1455. In this case, potential complexities in arriving at a customized data contract for the customer system 1455 are reduced because the schemas are known for emissions information (e.g., the raw emissions data sources) and taxonomies (e.g., enterprise taxonomies) to arrive at curated emissions datasets. Methodologies are discoverable by the PCF orchestrator 1440 and may be utilized by adhering to the data contract customized for the customer system 1455.

The data contract generated by the PCF orchestrator 1440 for the customer system 1455 may be used by the customer system 1455 to prepare the emissions data. While data preparation cannot be eliminated, the customized data contract generated by the PCF orchestrator 1440 may be used by the customer system 1455 to accelerate the process. In this case, the PCF orchestrator 1440 ties a methodology implementation to a flat data contract that allows internal teams, independent software vendors (ISVs), and/or consulting firms for the customer 1450 to provide implementations of the customized data contract using the customer system 1455.

The flowchart 1596 of FIG. 15 shows a scenario where the methodology includes data orchestration. In this example, the PCF orchestrator 1540 generates the customized data contract, which includes schema instructions that are used by the customer system 1555 to prepare the emissions data. This initial orchestration from the PCF orchestrator 1540 instructs the customer data environment to perform calculations within the customer system 1555. The prepared emissions data is then delivered to a data and computation environment within the customer system 1555.

Using customized instructions (e.g., containing sequenced calculation instructions) provided by the PCF orchestrator 1540, the prepared emissions data is processed within the data and computation environment of the customer system 1555. The PCF orchestrator 1540 does not require access or a copy of the emissions data in order to instruct the customer system 1555 to perform the calculations needed to generate a PCF value. In this way, the raw and prepared emissions data may remain on-premises (within the customer system 1555) without requiring a data upload to or specific access by the PCF orchestrator 1540. This configuration reduces the IT burden and complexity (e.g., in terms of security) since the data does not leave the customer system 1555 and requires no specific platform deployment.

The flowchart 1696 of FIG. 16 shows a scenario where the methodology includes contract mapping for data transformation, using in-place data lineage and traceability with schema-based transformations. Specifically, the data mapping implemented by the PCF orchestrator 1640 links various sources of emissions data to the data contract developed by the PCF orchestrator 1640 for the customer system 1655 using schema related to the sources of data. The resulting data transformation instructions, as well as separate calculation instructions generated by the PCF orchestrator 1640 for the customer system 1655, are used within the data and computation environment of the customer system 1655 to generate the PCF value. This solution may accommodate schema translations between products and/or known emissions data standards on both the input and output side.

The instructions (e.g., instructions 767) generated for the customer system 1655 by the PCF orchestrator 1640 are additive and append, but do not change, information from input data sets. In addition, all inputs/output are recorded as-is relative to the specific run of the PCF calculation. This means the process is stateless and may be reproduced at any point in time. The instructions created for the customer system 1655 direct the customer system 1655 to produce new fields for calculations, lookups or any other function to preserve the integrity of the original dataset. Output datasets may be designed to be “wide” and reflect all inputs/outputs for a particular run, including any calculations themselves (e.g., C=A+B−D). Each step in a methodology implementation may be designed to store all inputs and outputs relative to the individual run ID in a location that is designed to be immutable. The inputs, outputs and assumptions following the instructions may be easily audited because they are recorded and cannot be tampered with. The PCF output may be re-produced by re-running the same Run ID at any point in time.

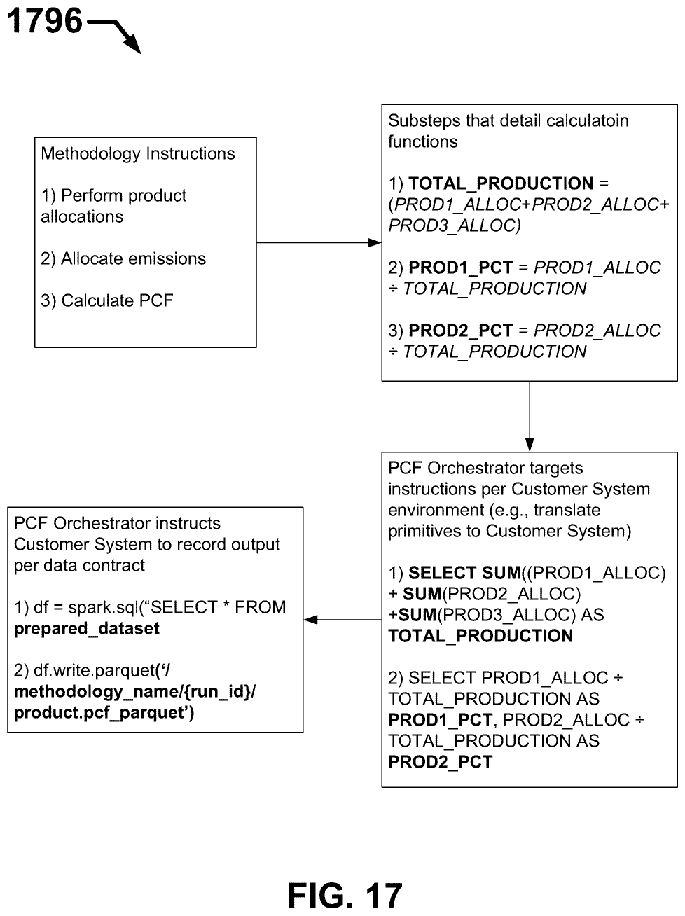

FIG. 17 shows a flowchart 1796 of a workflow methodology according to certain example embodiments. Referring to the description above with respect to FIGS. 1 through 16, the flowchart 1796 of FIG. 17 gives an example of how the PCF orchestrator 140 customizes instructions for the customer system 155 of a customer 150. The methodology in this example consists of a calculation function expressed as workflow steps. The results are then converted to a common language understood by the computing environment within the customer system 155. In the first step of the flowchart 1796, the methodology instructions, developed by the PCF orchestrator 140 specifically for the customer system 155 and delivered to the customer system 155, provide an ordered series of steps for the customer system 155 to follow.

In the second step of the flowchart 1796, each step of the instructions in the first step include one or more substeps that are developed by the PCF orchestrator 140 specifically for the customer system 155 and followed by the customer system 155. The third step of the flowchart 1796 gives an example of how the PCF orchestrator 140 may target instructions based on the environment of the customer system 155. The example in this case lists tailored instructions for translating primitives to the customer system 155. The fourth step of the flowchart 1796 gives an example of how the PCF orchestrator 140 may instruct the customer system 155 to record the output of its calculations per the data contract developed by the PCF orchestrator 140 for the customer system 155.

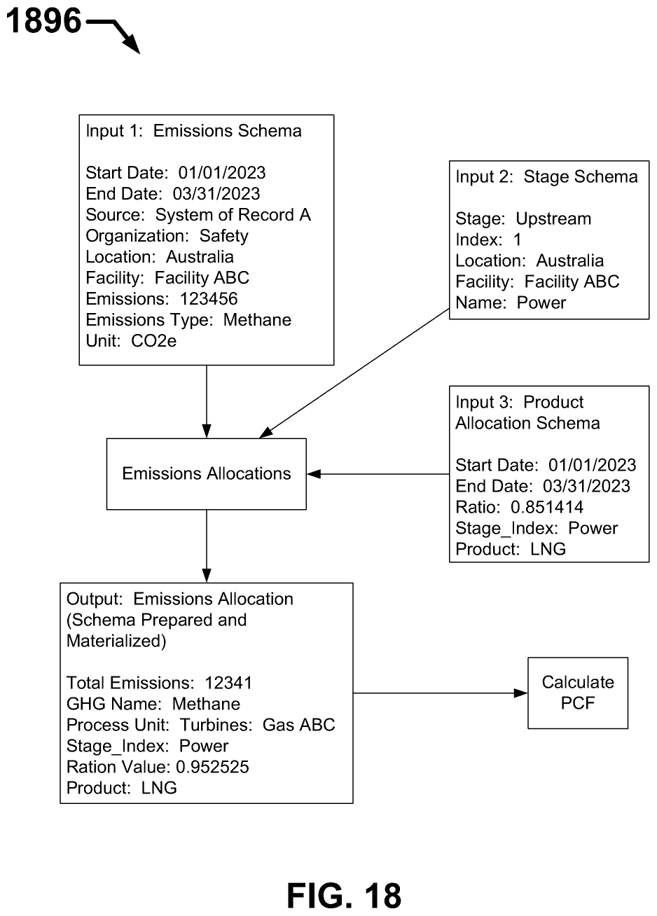

FIG. 18 shows a flowchart 1896 of another workflow methodology according to certain example embodiments. Referring to the description above with respect to FIGS. 1 through 17, the flowchart 1896 of FIG. 18 gives an example of how the data contract and the configuration of the customer system 155 and associated supplier systems 152 may inform the translation of emissions data. The methodology is tied to the data contract that describes the nature of the inputs and outputs. Specifically, the data contract describes the data structure that is generalized for customer systems 155 of customers 150.

The methodology allows the calculations, performed by the customer system 155 using instructions generated by the PCF orchestrator 140, to work in correct context and with correct assumptions about the emissions data. The translator uses the standard driven by the data contract to materialize outputs that are recorded and used in subsequent steps. For example, the emissions allocations may be based on methodology definitions and well-defined inputs (e.g., schemas). As another example, calculating the PCF may use the outputs from previous steps, along with any other supporting inputs, to produce a well-described output.

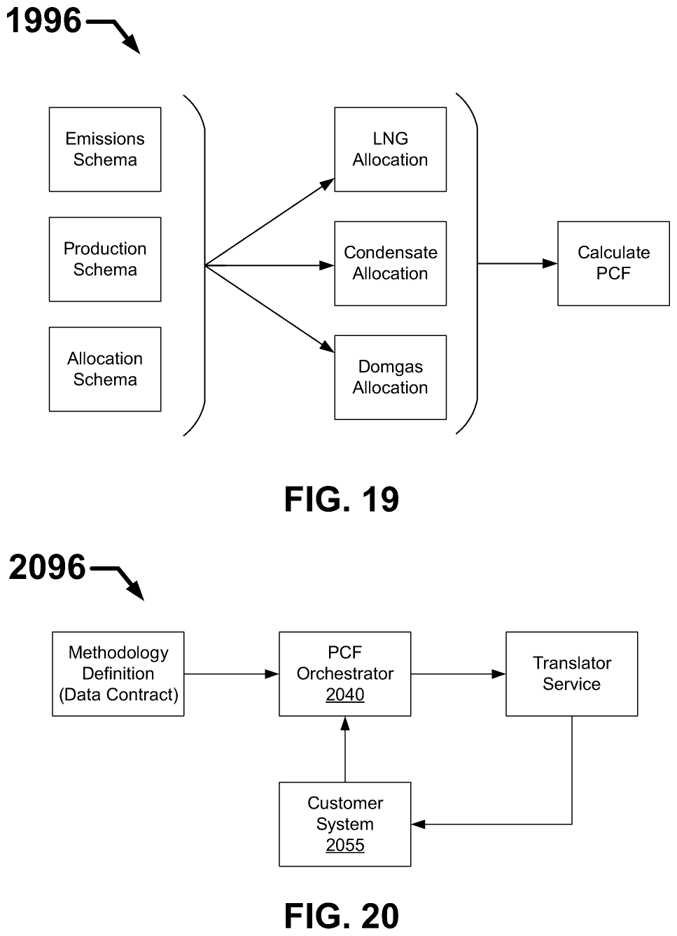

FIG. 19 shows a flowchart 1996 of a methodology construction according to certain example embodiments. Referring to the description above with respect to FIGS. 1 through 18, the flowchart 1996 of FIG. 19 shows how the methodology may be described as a document (e.g., in a JSON format) with a series of steps. Each step may contain inputs and outputs, where the inputs and outputs have a well-defined schema. The methodology, set forth in the instructions generated by the PCF orchestrator 140 for the customer system 155, may apply a “scoping predicate” to filter incoming input data and apply filters to one or more subsequent steps. The steps may also use “scoping predicates” to filter incoming data and/or some other predicate. For example, a scoped predicate indicating “Facility ABC” may exclude data outside the facility for any downstream steps and may not need to be individually configured. The methodologies used as the basis for data contracts may be more generic and as a result, may be shared across facilities or organizations.

FIG. 20 shows a flowchart 2096 of a workflow processing architecture according to certain example embodiments. Referring to the description above with respect to FIGS. 1 through 19, the flowchart 2096 of FIG. 20 shows how workflow processing architecture resolves the order of operations and translates instructions for the customer system 155. The methodology steps may include producers and consumers of information. Each step may contain components (e.g., user defined functions) that calculate individual properties. Each component may be converted to the computation environment of the customer system 155 via translation in the instructions.

The data contract and resulting instructions generated for the customer system 155 by the PCF orchestrator 140 describe inputs, outputs and operations to perform on data. The PCF orchestrator 140 may use a translator to convert general instructions to instructions understood by the software used on the customer system 155 (e.g., New_Column=(A+B)/C). In such a case, the translator may be part of the data contract so that the instructions generated by the PCF orchestrator 140 may be customized for the customer system 155.

In some cases, example embodiments can be directed to a computer-implemented method for providing a data contract and accompanying instructions to a customer for determining a product carbon footprint (PCF) of the customer. The computer-implemented method can include requesting query information about a customer; obtaining the query information from the customer; applying query information to a PCF determination package; generating the data contract and instructions, derived from the PCF determination package, using the query information, wherein the data contract is configured to receive a plurality of inputs in the form of emission-related data; and providing the data contract and the instructions to the customer. In some cases, the computer-implemented method can further include generating, after receiving the emission-related data, a PCF value for the customer; and providing the PCF value to the customer. In some cases, the computer-implemented method can further include providing an audit report for reaching the PCF value.

Example embodiments can be used to determine a PCF value for a customer. Such determination can be made using a standardized data contract and accompanying instructions that are delivered to a customer. The customer uses this data contract, following the instructions, to manipulate and enter the data needed to generate a PCF value for the customer. Example embodiments allow the customer to maintain control of its data rather than be required to provide its data to a third party. Example embodiments can be updated in real time to account for changes in law, regulations, standards, and/or other sources that can influence changes in how the PCF is determined. Example embodiments eliminate or greatly reduce the need for human involvement in the manipulation of data, entering data, and/or determining the PCF value. Example embodiments also provide a number of other benefits. Such other benefits can include, but are not limited to, less use of resources, greater operational flexibility, time savings, standardized processes, reliable PCF values, and compliance with applicable industry standards and regulations.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A product carbon footprint (PCF) orchestrator comprising:
a controller configured to:
generate a PCF determination package, wherein the PCF determination package comprises a data contract and instructions that are customized for a customer system of a customer based on query information provided by a customer system, wherein the data contract is configured to receive a plurality of inputs in the form of emission-related data, and wherein the data contract and instructions are configured to instruct the customer system as to how to format the emission-related data;
send the PCF determination package to the customer system, wherein the emissions-related data remains with the customer system when the instructions are followed to generate the PCF results;
obtain PCF results from the customer system after the customer system uses the data contract following the instructions of the PCF determination package; and
evaluate the PCF results, wherein emission data used by the customer system to generate the PCF results are not accessed by the controller.

2. The PCF orchestrator of claim 1, wherein the controller is further configured to:
identify a change in a source used to generate the PCF determination package;
generate a modified PCF determination package based on the change in the source; and
send the modified PCF determination package to the customer system.

3. The PCF orchestrator of claim 1, wherein the controller is further configured to:
identify third party sources relevant to PCFs;
obtain relevant information relevant to the PCFs from the third party sources;
generate a methodology for product and emissions allocations; and
generate a table for receiving customer emission data.

4. The PCF orchestrator of claim 1, wherein the data contract is based on an industry in which the customer participates, and wherein the instructions are generated on the customer system based on data sources and software used by the customer system to generate the PCF results.

5. The PCF orchestrator of claim 4, wherein the PCF determination package is generic to all customers that participate in the industry.

6. The PCF orchestrator of claim 1, wherein the instructions are based on a software package, residing on the customer system, used by the customer to generate the PCF results.

7. The PCF orchestrator of claim 6, wherein the data contract includes a translator that translates the instructions for the software package, residing on the customer system, used by the customer system to generate the PCF results.

1. CF orchestrator of claim 1, wherein the controller is further configured to:
obtain query information from the customer system, wherein the data contract is derived using the query information.

9. The PCF orchestrator of claim 1, wherein the PCF determination package generates an audit trail each time the customer system generates the PCF results.

10. The PCF orchestrator of claim 1, wherein the PCF determination package is accessible through a secure portal for a website.

11. The PCF orchestrator of claim 1, wherein the data contract comprises mapping data from each data source of the customer for generating the PCF results.

12. A computer-implemented method for orchestrating the determination of a product carbon footprint (PCF), the computer-implemented method comprising:
generating, by a PCF orchestrator, a PCF determination package, wherein the PCF determination package comprises a data contract and instructions that are customized for a customer system of a customer based on query information provided by a customer system, wherein the data contract is configured to receive a plurality of inputs in the form of emission-related data, and wherein the data contract and instructions are configured to instruct the customer system as to how to format the emission-related data;
sending, by the PCF orchestrator, the PCF determination package to the customer system, wherein the emissions-related data remains with the customer system when the instructions are followed to generate the PCF results;
obtaining, by the PCF orchestrator, PCF results from the customer system after the customer system uses the data contract following the instructions of the PCF determination package; and
evaluating, by the PCF orchestrator, the PCF results, wherein emission data used by the customer system to generate the PCF results are not accessed by the PCF orchestrator.

13. The computer-implemented method of claim 12, further comprising:
identifying a change in a source used to generate the PCF determination package for the customer;
generating a modified PCF determination package for the customer based on the change in the source; and
sending the modified PCF determination package to the customer system.

14. The computer-implemented method of claim 12, wherein the instructions comprise steps and substeps that detail calculation functions performed by the customer system to generate the PCF results.

15. The computer-implemented method of claim 12, wherein the instructions are configured to allow the customer system to generate the PCF results for the customer.

16. The computer-implemented method of claim 12, wherein the PCF determination package is derived from a general template that applies to a plurality of customer systems of a plurality of customers, wherein the plurality of customer systems comprises the customer system, and wherein the plurality of customers comprises the customer.

17. The computer-implemented method of claim 12, wherein the PCF determination package is generated by:
identifying third party sources relevant to PCFs;
obtaining relevant information relevant to the PCFs from the third party sources;
generating a methodology for product and emissions allocations; and
generating a table for receiving customer emission data.

18. The computer-implemented method of claim 12, wherein the data contract includes weighting factors that are applied to at least some of the emission-related data.

19. The computer-implemented method of claim 18, wherein the weighting factors are used to generate weighting values for at least some of the emission-related data.

20. The computer-implemented method of claim 19, wherein the weighting values are used to generate allocated emissions values.
